(19) United States
(12) Patent Application Publication
(10) Pub. No.: US 2009/0237601 A1
(43) Pub. Date: Sep. 24, 2009

(54) POLARIZING PLATE WITH AN OPTICAL COMPENSATION LAYER, LIQUID CRYSTAL PANEL, LIQUID CRYSTAL DISPLAY APPARATUS, AND IMAGE DISPLAY APPARATUS USING THE POLARIZING PLATE WITH AN OPTICAL COMPENSATION LAYER

(75) Inventors: Shunsuke Shutou, Osaka (JP); Youji Ishihara, Osaka (JP); Junichi Nagase, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/090,752

(22) PCT Filed: Oct. 11, 2006
(86) PCT No.: PCT/JP2006/320305

§ 371 Date: Apr. 7, 2009

(30) Foreign Application Priority Data
Oct. 21, 2005 (JP) 2005-307308
Mar. 6, 2006 (JP) 2006-059087

(51) Int. Cl. G02F 1/13363; G02B 5/30

(52) U.S. Cl. 349/118; 359/499

(57) ABSTRACT

Provided are a polarizing plate with an optical compensation layer capable of contributing to the reduction in thickness, enhancing viewing angle properties, realizing a high contrast, preventing interference uneveness and heat uneveness, suppressing a color shift, realizing satisfactory color reproducibility, and preventing light leakage in a black display satisfactorily, and a liquid crystal panel, a liquid crystal display apparatus, and an image display apparatus using the polarizing plate with an optical compensation layer. The polarizing plate with an optical compensation layer of the present invention includes, in the stated order, a polarizer, a first optical compensation layer, an adhesive layer, and a second optical compensation layer, in which the first optical compensation layer has a refractive index profile of nx>ny=nz, exhibits wavelength dispersion properties that an in-plane retardation Re₁ is smaller toward a short wavelength side, and has an in-plane retardation Re₁ of 90 to 160 nm, and the second optical compensation layer is a coating layer, has a refractive index profile of nx=ny>nz and has an in-plane retardation Re₂ of 0 to 20 nm, a thickness direction retardation Rth₂ of 30 to 300 nm, and a thickness of 0.5 to 10 μm.

### TECHNICAL FIELD

The present invention relates to a polarizing plate with an optical compensation layer, and a liquid crystal panel, a liquid crystal display apparatus, and an image display apparatus using the polarizing plate with an optical compensation layer. More specifically, the present invention relates to a polarizing plate with an optical compensation layer capable of contributing to reduction in thickness and preventing heat uneveness and light leakage in a black display, and a liquid crystal panel, a liquid crystal display apparatus, and an image display apparatus using the polarizing plate with an optical compensation layer.

### BACKGROUND ART

As a liquid crystal display apparatus of a VA mode, a semi-transmission reflection-type liquid crystal display apparatus has been proposed in addition to a transmission-type liquid crystal display apparatus and a reflection-type liquid crystal display apparatus (for example, see Patent Documents 1 and 2). The semi-transmission reflection-type liquid crystal display apparatus enables a display to be recognized visually by using ambient light in a light place in the same way as in the reflection-type liquid crystal display apparatus, and using an internal light source such as a backlight in a dark place. In other words, the semi-transmission reflection-type liquid crystal display apparatus employs a display system of both a reflection-type and a transmission-type, and switches a display mode between a reflection mode and a transmission mode depending upon the ambient brightness. As a result, the semi-transmission reflection-type liquid crystal display apparatus can perform a clear display even in a dark place with the reduction of the power consumption. Therefore, the semi-transmission reflection-type liquid crystal display apparatus can be used preferably for a display part of mobile equipment, for instance.

A specific example of such a semi-transmission reflection-type liquid crystal display apparatus includes a liquid crystal display apparatus that includes a reflective film, which is obtained by forming a window portion for transmitting light on a film made of metal such as aluminum, on an inner side of a lower base material, and allows the reflective film to function as a semi-transmission reflective plate. In the liquid crystal display apparatus described above, in the case of the reflection mode, ambient light entered from an upper base material side passes through a liquid crystal layer, is reflected by the reflective film on the inner side of the lower base material, passes through the liquid crystal layer again, and outgoes from an upper base material side, thereby contributing to a display. On the other hand, in the transmission mode, light from the backlight entered from the lower base material side passes through the liquid crystal layer through the window part of the reflective film, and outgoes from the upper base material side, thereby contributing to a display. Thus, in a region where the reflective film is formed, an area in which the window part is formed functions as a transmission display region, and the other area functions as a reflection display region. However, in the conventional reflection or semi-transmission reflection-type liquid crystal display apparatus of a VA mode, light leakage occurs in a black display to cause a problem of degradation of a contrast, which has been not overcome for a long time.

As an attempt to solve the above-mentioned problem, a lamination retardation layer including: a lamination of a retardation film having wavelength dispersion properties, in which a retardation value decreases toward a short wavelength side; and a retardation layer formed of a coating layer of liquid crystal directly applied thereto (for example, see Patent Document 3). However, in the lamination retardation layer, a liquid crystal monomer dissolved in an organic solvent is directly applied onto the retardation film, so the organic solvent erodes the retardation film. Consequently, there occurs a problem in that the retardation film is damaged to become opaque. Further, when the coating layer of liquid crystal is directly applied to the retardation film, there is a problem that the coating layer of liquid crystal is likely to peel from the retardation film, and hence, practical use (for example, resistance for high temperature and high humidity) cannot be achieved.

### Patent Document 1: JP 11-242226 A

### Patent Document 2: JP 2001-209065 A

### Patent Document 3: JP 2004-326089 A

### DISCLOSURE OF THE INVENTION

### Problems to be Solved by the Invention

An object of the present invention is to provide: a polarizing plate with an optical compensation layer capable of contributing to the reduction in thickness, enhancing viewing angle properties, realizing a high contrast, preventing interference uneveness and heat uneveness, suppressing a color shift, realizing satisfactory color reproducibility, and preventing light leakage in a black display satisfactorily; and a liquid crystal panel, a liquid crystal display apparatus, and an image display apparatus using the polarizing plate with an optical compensation layer.

### Means for Solving the Problems

A polarizing plate with an optical compensation layer of the present invention includes, in the stated order, a polarizer, a first optical compensation layer, an adhesive layer, and a second optical compensation layer, in which: the first optical compensation layer has a refractive index profile of nx>ny=nz, exhibits wavelength dispersion properties that an in-plane retardation Re₁ is smaller toward a short wavelength side, and has an in-plane retardation Re₁ of 90 to 160 nm; and the second optical compensation layer is a coating layer and has a refractive index profile of nx=ny>nz, an in-plane retardation Re₂ of 0 to 20 nm, a thickness direction retardation Rth₂ of 30 to 300 nm, and a thickness of 0.5 to 10 μm.

In a preferred embodiment, the adhesive layer is formed of an isocyanate resin-based adhesive layer.

In a preferred embodiment, the first optical compensation layer is a stretched film layer and contains polycarbonate having a fluorene skeleton.

In a preferred embodiment, the first optical compensation layer is a stretched film layer and contains a cellulose-based material.

In a preferred embodiment, the first optical compensation layer contains a cellulose-based material in which an acetyl substitution degree (DSac) and a propionyl substitution degree (DSpr) satisfy 2.0≦DSac+DSpr≦3.0 and 1.0≦DSpr≦3.0.

In a preferred embodiment, the first optical compensation layer is a stretched film layer obtained by subjecting the cellulose-based material to free-end uniaxial stretching at 110° C. to 170° C. in a major axis direction by 1.1 times to 2.5 times.

In a preferred embodiment, a weight average molecular weight Mw of the cellulose-based material is in a range of 3×10³ to 3×10⁵.

In a preferred embodiment, the first optical compensation layer is a stretched film layer and contains two or more kinds of an aromatic polyester polymers having different wavelength dispersion properties.

In a preferred embodiment, the first optical compensation layer is a stretched film layer and contains a copolymer having two or more kinds of monomer units derived from a monomer forming a polymer having different wavelength dispersion properties.

In a preferred embodiment, the first optical compensation layer is a complex film layer in which two or more kinds of stretched film layers having different wavelength dispersion properties are laminated.

In a preferred embodiment, the second optical compensation layer is formed of a cholesteric alignment fixed layer.

In a preferred embodiment, the second optical compensation layer is formed of a layer containing a non-liquid crystalline material.

In a preferred embodiment, the second optical compensation layer is formed by transferring the second optical compensation layer formed onto a base material by coating to the first optical compensation layer via the adhesive layer.

According to another aspect of the present invention, a liquid crystal panel is provided. The liquid crystal panel includes the above polarizing plate with an optical compensation layer and a liquid crystal cell.

In a preferred embodiment, the liquid crystal cell is a VA mode of a reflection type or semi-transmission type.

According to still another aspect of the present invention, a liquid crystal display apparatus is provided. The liquid crystal display apparatus includes the liquid crystal panel.

According to still another aspect of the present invention, an image display apparatus is provided. The image display apparatus includes the polarizing plate with an optical compensation layer.

### EFFECT OF THE INVENTION

According to the present invention, there can be provided: a polarizing plate with an optical compensation layer capable of contributing to the reduction in thickness, enhancing viewing angle properties, realizing a high contrast, preventing interference uneveness and heat uneveness, suppressing a color shift, realizing satisfactory color reproducibility, and preventing light leakage in a black display satisfactorily; and a liquid crystal panel, a liquid crystal display apparatus, and an image display apparatus using the polarizing plate with an optical compensation layer.

The above-mentioned effect can be realized by providing a polarizing plate with an optical compensation layer including a polarizer, a first optical compensation layer, an adhesive layer, and a second optical compensation layer in the stated order, in which: the first optical compensation layer has a refractive index profile of nx>ny=nz, exhibits such wavelength dispersion properties that a retardation value that is an optical path difference between extraordinary light and ordinary light smaller toward a short wavelength side, and has the in-plane retardation Re₁ of the first optical compensation layer is set to be in a predetermined range; and the second optical compensation layer is a coating layer having a refractive index profile of nx=ny>nz, and an in-plane retardation Re₂ and a thickness direction retardation Rth₂ are set in predetermined ranges.

In the present invention, an adhesive layer is used between the first optical compensation layer and the second optical compensation layer, whereby it is not necessary to form the second optical compensation layer by directly applying a coating solution to the first optical compensation layer. Therefore, the corrosion of the first optical compensation layer by an organic solvent can be prevented, and the first optical compensation layer can be prevented from becoming opaque.

In the present invention, the second optical compensation layer is thin, and can greatly contribute to the reduction in thickness of the liquid crystal panel. Further, heat unevenness can be prevented by forming thin second optical compensation layer.

### BRIEF DESCRIPTION OF THE DRAWINGS

FIG. 1 is a schematic cross-sectional view of a polarizing plate with an optical compensation layer according to a preferred embodiment of the present invention.

FIG. 2 is a schematic cross-sectional view of a liquid crystal panel used in a liquid crystal display apparatus according to a preferred embodiment of the present invention.

### DESCRIPTION OF SYMBOLS

10 polarizing plate with optical compensation layer
11 polarizer
12 first optical compensation layer
13 adhesive layer
14 second optical compensation layer
20 liquid crystal cell
100 liquid crystal panel

### BEST MODE FOR CARRYING OUT THE INVENTION

### Definitions of Terms and Symbols

Definitions of terms and symbols in the specification of the present invention are described below.

(1) The symbol “nx” refers to a refractive index in a direction providing a maximum in-plane refractive index (that is, slow axis direction), the symbol “ny” refers to a refractive index in a direction perpendicular to the slow axis in the plane (that is, fast axis direction), and the symbol “nz” refers to a refractive index in a thickness direction. Further, the expression “nx=ny”, for example, not only refers to a case where nx and ny are exactly equal to each other, but also includes a case where nx and ny are substantially equal to each other. In the specification of the present invention, the phrase “substantially equal” includes a case where nx and ny differ within a range providing no effects on overall polarization properties of a polarizing plate with an optical compensation layer in practical use.

(2) The term “in-plane retardation Re” refers to an in-plane retardation value of a film (layer) measured at 23° C. by using light of a wavelength of 590 nm. Re can be determined from an equation: Re=(nx−ny)×d, where nx and ny represent refractive indices of a film (layer) at a wavelength of 590 nm in a slow axis direction and a fast axis direction, respectively, and d (nm) represents a thickness of the film (layer).

(3) The term “thickness direction retardation Rth” refers to a thickness direction retardation value measured at 23° C. by using light of a wavelength of 590 nm. Rth can be determined from an equation: Rth=(nx−nz)×d, where nx and nz represent refractive indices of a film (layer) at a wavelength of 590 nm in a slow axis direction and a thickness direction, respectively, and d (nm) represents a thickness of the film (layer).

(4) The subscript “1” attached to a term or symbol described in the specification of the present invention represents a first optical compensation layer. The subscript “2” attached to a term or symbol described in the specification of the present invention represents a second optical compensation layer.

(5) The term “λ/2 plate” refers to a plate having a function of converting linearly polarized light having a specific vibration direction into linearly polarized light having a vibration direction perpendicular thereto, or converting right-handed circularly polarized light into left-handed circularly polarized light (or converting left-handed circularly polarized light into right-handed circularly polarized light). The λ/2 plate has an in-plane retardation value of a film (layer) of about ½ with respect to a predetermined light wavelength (generally, in a visible light region).

(6) The term “λ/4 plate” refers to a plate having a function of converting linearly polarized light of a specific wavelength into circularly polarized light (or converting circularly polarized light into linearly polarized light) The λ/4 plate has an in-plane retardation value of a film (layer) of about ¼ with respect to a predetermined light wavelength (generally, in a visible light region).

(7) The term “cholesteric alignment fixed layer” refers to a layer in which constituent molecules of the layer have a helical structure, a helical axis thereof is aligned substantially perpendicularly with respect to a plane direction, and an alignment state thereof is fixed. Thus, the “cholesteric alignment fixed layer” includes not only the case where a liquid crystal compound exhibits a cholesteric liquid crystal phase, but also the case where a non-liquid crystalline compound has a pseudo structure as in a cholesteric liquid crystal phase. For example, the “cholesteric alignment fixed layer” can be formed by allowing a liquid crystal material to be aligned in a cholesteric structure (helical structure) by providing the liquid crystal material with distortion, using a chiral agent in a state where the liquid crystal material exhibits a liquid crystal phase, and subjecting the liquid crystal material in this state to polymerization or cross-linking treatment, thereby fixing the alignment (cholesteric structure) of the liquid crystal material.

(8) The term “the wavelength range of selective reflection is 350 nm or less” means that a center wavelength λ of the wavelength range of selective reflection is 350 nm or less. For example, in the case where the cholesteric alignment fixed layer is formed using a liquid crystal monomer, the center wavelength λ of the wavelength range of selective reflection is represented by the following expression:

λ=n×P

where n represents an average refractive index of a liquid crystal monomer and P represents a helical pitch (nm) of the cholesteric alignment fixed layer. The average refractive index n is represented by (nₒ+nₑ)/2, and is generally in the range of 1.45 to 1.65. n₀ represents an ordinary light refractive index of the liquid crystal monomer, and nₑ represents an extraordinary light refractive index of the liquid crystal monomer.

(9) The term “chiral agent” refers to a compound having a function of aligning a liquid crystal material (for example, a nematic liquid crystal) so that the material has a cholesteric structure.

(10) The term “distortion force” refers to the ability of a chiral agent of providing a liquid crystal material with distortion to align the liquid crystal material in a cholesteric structure (helical structure). In general, the distortion force is represented by the following expression:

Distortion force=1/(P×W)

where P represents a helical pitch (nm) of the cholesteric alignment fixed layer, as described above and W represents a chiral agent weight ratio. A chiral agent weight ratio W is represented by W=[X/(X+Y)]×100. Herein, X represents the weight of a chiral agent, and Y represents the weight of a liquid crystal material.

A. Polarizing Plate with an Optical Compensation Layer

A-1. Entire Constitution of Polarizing Plate with an Optical Compensation Layer

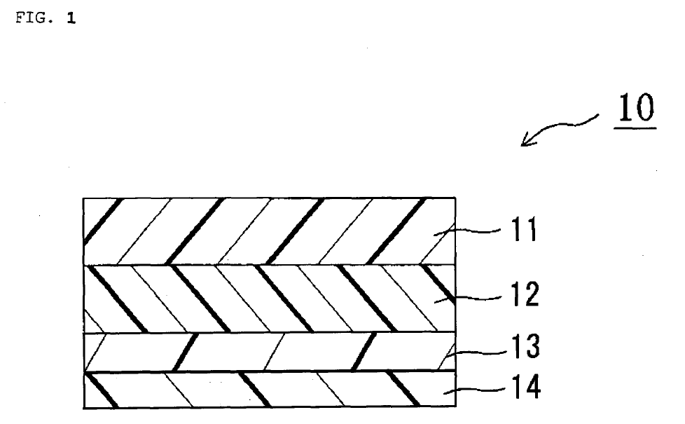

FIG. 1 is a schematic sectional view of a polarizing plate with an optical compensation layer according to a preferred embodiment of the present invention. As shown in FIG. 1, a polarizing plate with an optical compensation layer 10 includes a polarizer 11, a first optical compensation layer 12, an adhesive layer 13, and a second optical compensation layer 14 in the stated order.

The polarizer 11 and the first optical compensation layer 12 are laminated via any suitable pressure-sensitive adhesive layer or adhesive layer (not shown). Practically, any suitable protective layer (not shown) is laminated on a side of the polarizer 11, the side being a side on which the optical compensation layer is not formed. Further, if required, a protective layer is provided between the polarizer 11 and the first optical compensation layer 12.

The polarizing plate with an optical compensation layer of the present invention has a total thickness of preferably 100 to 320 μm, more preferably 115 to 310 μm, and still more preferably 115 to 300 μm. Accordingly, the present invention may greatly contribute to reduction in thickness of an image display apparatus (for example, liquid crystal display apparatus).

A-2. First Optical Compensation Layer

The first optical compensation layer is a positive A-plate having a refractive index profile of nx>ny=nz for use as a circularly polarization mode in a semi-transmission reflection-type liquid crystal display apparatus, particularly, of a VA mode (vertical alignment mode).

The first optical compensation layer has a refractive index profile of nx>ny=nz, and the brightness of the liquid crystal display apparatus is enhanced by using the above refractive index profile.

The first optical compensation layer exhibits wavelength dispersion properties in which an in-plane retardation Re₁ is smaller toward a short wavelength side.

Preferred examples of the first optical compensation layer include a stretched film layer containing a liquid crystal and polycarbonate having a fluorine skeleton (for example, described in JP 2002-48919 A), a stretched film layer containing a cellulose-based material (for example, described in JP 2003-315538 and JP 2000-137116 A), a stretched film layer containing two or more kinds of aromatic polyester polymers having different wavelength dispersion properties (for example, described in JP 2002-14234 A), a stretched film layer containing a copolymer having two or more kinds of monomer units derived from monomers forming polymers having different wavelength dispersion properties (described in WO 00/26705), and a complex film layer in which two or more kinds of stretched film layers having different wavelength dispersion properties are laminated (described in JP 02-120804 A).

As a material for forming the first optical compensation layer, for example, a single polymer (homopolymer), a copolymer, or a blend of a plurality of polymers may be used. The blend is preferably composed of compatible polymers or polymers having substantially equal refractive indices because the blend needs to be optically transparent. As a material for forming the first optical compensation layer, for example, a polymer described in JP 2004-309617 A can be used preferably.

Specific examples of the combination of the blend are as follows: a combination of a poly(methylmethacrylate) as a polymer having negative optical anisotropy and a poly(vinylydene fluoride), a poly(ethylene oxide), or a vinylydene fluoride/trifluoroethylene copolymer as a polymer having positive optical anisotropy; a combination of a polystyrene, a styrene/lauroylmaleimide copolymer, a styrene/cyclohexyl maleimide copolymer, or a styrene/phenyl maleimide copolymer as a polymer having negative optical anisotropy and a poly(phenylene oxide) as a polymer having positive optical anisotropy; a combination of a styrene/maleic anhydride copolymer as a polymer having negative optical anisotropy and a polycarbonate as a polymer having positive optical anisotropy; and a combination of an acrylonitrile/styrene copolymer as a polymer having negative optical anisotropy and an acrylonitrile/butadiene copolymer as a polymer having positive optical anisotropy. Of those, a combination of a polystyrene as a polymer having negative optical anisotropy and a poly(phenylene oxide) as a polymer having positive optical anisotropy is preferred from the viewpoint of transparency. As the poly(phenylene oxide), poly(2,6-dimethyl-1,4-phenylene oxide) is exemplified.

Examples of the copolymer include a butadiene/styrene copolymer, an ethylene/styrene copolymer, an acrylonitrile/butadiene copolymer, an acrylonitrile/butadiene/styrene copolymer, a polycarbonate-based copolymer, a polyester-based copolymer, a polyestercarbonate-based copolymer, and a polyarylate-based copolymer. Particularly preferred are a polycarbonate having a fluorene skeleton, a polycarbonate-based copolymer having a fluorene skeleton, a polyester having a fluorene skeleton, a polyester-based copolymer having a fluorene skeleton, a polyestercarbonate having a fluorene skeleton, a polyestercarbonate-based copolymer having a fluorene skeleton, a polyarylate having a fluorene skeleton, and a polyarylate-based copolymer having a fluorene skeleton, because it is possible for a segment having a fluorene skeleton to have negative optical anisotropy.

As the cellulose-based material, any suitable cellulose-based material may be selected. Specific examples of the cellulose-based material include: cellulose esters such as cellulose acetate and cellulose butyrate; and cellulose ethers such as methyl cellulose and ethyl cellulose. Preferably, cellulose esters such as cellulose acetate and cellulose butyrate are used, and more preferably, cellulose acetate is used. Further, the cellulose-based material may contain an additive such as a plasticizer, a heat stabilizer, and a UV-stabilizer, if required.

A weight average molecular weight Mw of the cellulose-based material is in the range of preferably 3×10³ to 3×10⁵, and more preferably 8×10³ to 1×10⁵. By setting the weight average molecular weight Mw in the above range, excellent productivity and satisfactory mechanical strength can be obtained.

The cellulose-based material may have an appropriate substituent depending upon the purpose. Examples of the substituent include: ester groups such as acetate and butyrate; ether groups such as an alkyl ether group and an aralkylene ether group; an acetyl group; and a propionyl group.

It is preferred that the cellulose-based material be substituted by an acetyl group and a propionyl group. The lower limit of the substitution degree of the cellulose-based material “DSac (acetyl substitution degree)+DSpr (propionyl substitution degree)” (showing how much three hydroxyl groups present in a repetition unit of cellulose are substituted, on average, by an acetyl group or a propionyl group) is preferably 2 or more, more preferably 2.3 or more, and still more preferably 2.6 or more. The upper limit of “DSac+DSpr” is preferably 3 or less, more preferably 2.9 or less, and still more preferably 2.8 or less. By setting the substitution degree of the cellulose-based material in the above range, an optical compensation layer having a desired refractive index profile as described above can be obtained.

The lower limit of the above DSpr (propionyl substitution degree) is preferably 1 or more, more preferably 2 or more, and still more preferably 2.5 or more. The upper limit of the DSpr is preferably 3 or less, more preferably 2.9 or less, and still more preferably 2.8 or less. By setting the DSpr in the above range, the solubility of the cellulose-based material with respect to a solvent is enhanced, and the thickness of a first optical compensation layer to be obtained can be controlled easily. Further, by setting “DSac+DSpr” in the above range, and setting the DSpr in the above range, an optical compensation layer having the above optical properties and having reverse wavelength dispersion dependency can be obtained.

The above acetyl substitution degree (DSac) and propionyl substitution degree (DSpr) can be obtained by a method described in paragraphs [0016] to [0019] in JP 2003-315538 A.

A method of substituting by the acetyl group and propionyl group may employ any appropriate method. For example, a cellulose may be treated with a strong caustic soda solution to prepare an alkali cellulose, and the alkali cellulose and a predetermined amount of a mixture of acetic anhydride and propionic anhydride are mixed for acylation. An acyl group is partly hydrolyzed for adjusting the degree of substitution “DSac+DSpr”.

The first optical compensation layer can function as a λ/4 plate. An in-plane retardation Re₁ of the first optical compensation layer is preferably 90 to 160 nm, more preferably 100 to 150 nm, and still more preferably 110 to 140 nm.

The thickness of the first optical compensation layer can be set so as to function as a λ/4 plate most suitably. In other words, the thickness can be set so that a desired in-plane retardation Re₁ is obtained. Specifically, the thickness of the first optical compensation layer is preferably 42 to 130 μm, more preferably 45 to 125 μm, and still more preferably 48 to 120 μm.

The in-plane retardation Re₁ of the first optical compensation layer can be controlled by changing the stretching ratio and the stretching temperature of a resin film exhibiting the above wavelength dispersion properties (reverse wavelength dispersion properties).

The stretching ratio can vary depending upon the in-plane retardation value Re₁ desired in the first optical compensation layer, the thickness desired in the first optical compensation layer, the kind of a resin to be used, the thickness of a film to be used, the stretching temperature, and the like. Specifically, the stretching ratio is preferably 1.1 to 2.5 times, more preferably 1.25 to 2.45 times, and still more preferably 1.4 to 2.4 times. By stretching with such a stretching ratio, a first optical compensation layer having an in-plane retardation Re₁ capable of sufficiently exhibiting the effect of the present invention and a refractive index profile of nx>ny=nz can be obtained.

The stretching temperature can appropriately vary depending upon the in-plane retardation Re₁ desired in the first optical compensation layer, the thickness desired in the first optical compensation layer, the kind of a resin to be used, the thickness of a film to be used, the stretching ratio, and the like. Specifically, the stretching temperature is preferably 100 to 250° C., more preferably 105 to 240° C., and still more preferably 110 to 240° C. By stretching at such a stretching temperature, a first optical compensation layer having an in-plane retardation Re₁ capable of sufficiently exhibiting the effect of the present invention and a refractive index profile of nx>ny=nz can be obtained.

As a stretching method, any suitable method can be adopted as long as the optical properties and thickness as described above can be obtained. Specific examples of the stretching method include free-end stretching and fixed-end stretching. Preferably, free-end uniaxial stretching is used, and more preferably, free-end longitudinal uniaxial stretching is used. By stretching a film by the stretching method, a first optical compensation layer that has an in-plane retardation Re₁ to exhibit the effects of the present invention sufficiently, and has a refractive index profile of nx>ny=nz.

In the case where the first optical compensation layer is a stretched film layer containing the above cellulose-based material, preferably, a stretching ratio is 1.1 times to 2.5 times, a stretching temperature is 110° C. to 170° C., and a stretching method is free-end longitudinal uniaxial stretching.

Any suitable method can be employed as the method of forming a first optical compensation layer without being particularly limited. For example, there is a method of preparing a solution in which the formation material is dissolved in a solvent, applying the solution onto a smooth base material film or a metallic endless belt in a film shape, and removing the solvent by evaporation, thereby forming a first optical compensation layer.

Examples of the solvent for applying the solution include, but are not particularly limited to, for example: halogenated hydrocarbons such as chloroform, dichloromethane, carbon tetrachloride, dichloroethane, tetrachloroethane, trichloroethylene, tetrachloroethylene, chlorobenzene, and orthodichlorobenzene; phenols such as phenol, parachlorophenol; aromatic hydrocarbons such as benzene, toluene, xylene, methoxybenzene, and 1,2-dimethoxybenzene; ketone-based solvents such as acetone, methyl ethyl ketone, methyl isobutyl ketone, cyclohexanone, cyclopentanone, 2-pyrrolidone, and N-methyl-2-pyrrolidone; ester-based solvents such as ethyl acetate and butyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide-based solvents such as dimethylformamide and dimethylacetamide; nitrile-based solvents such as acetonitrile and butyronitrole; ether-based solvents such as diethyl ether, dibutyl ether, and tetrahydrofuran; carbon disulfide; and cellosolves such as ethyl cellosolve and butyl cellosolve. The solvents may be used alone or in combination.

Any suitable method can be adopted as the application methods without being particularly limited. For example, spin coating, roll coating, flow coating, printing, dip coating, casting deposition, bar coating, and gravure printing are mentioned. Further, in coating, a method of superimposing a polymer layer may also be employed as required.

Any suitable material can be employed as the material for forming the base material film without being particularly limited. For example, a polymer excellent in transparency is preferred, and a thermoplastic resin is also preferred because it is suitable for stretching treatment and shrinking treatment.

The thickness of the base material film is preferably 10 to 1000 μm, more preferably 20 to 500 μm, and still more preferably 30 to 100 μm.

A-3. Second Optical Compensation Layer

A-3-1. Entire Configuration of a Second Optical Compensation Layer

The second optical compensation layer 14 is a coating layer, has a relationship of nx=ny>nz, and can function as a so-called negative C plate. Because the second optical compensation layer has such a refractive index profile, in particular, the birefringence of a liquid crystal layer in a liquid crystal cell of a VA mode can be compensated satisfactorily. More specifically, the second optical compensation layer is used for preventing the viewing angle properties from being degraded by losing isotropy due to the influence of liquid crystal molecules when viewed from an oblique direction in a liquid crystal display apparatus of a VA mode (vertical alignment mode). As a result, a liquid crystal display apparatus in which viewing angle properties are enhanced remarkably can be obtained.

In the specification of the present invention, the term “nx=ny” includes not only the case where nx and ny are exactly equal to each other but also the case where nx and ny are substantially equal to each other. Therefore, the second optical compensation layer may have an in-plane retardation Re₂, and may have a slow axis. The in-plane retardation Re₂ allowable practically as a negative C plate is 0 to 20 nm, preferably 0 to 10 nm, and more preferably 0 to 5 nm. A thickness direction retardation Rth₂ of the second optical compensation layer is 30 to 300 nm, preferably 60 to 180 nm, more preferably 80 to 150 nm, and still more preferably 100 to 120 nm.

The thickness of the second optical compensation layer is 0.5 to 10 μm, preferably 1.0 to 8 μm, and more preferably 1.5 to 5 μm. Thus, the thickness of the second optical compensation layer in the present invention is small, which can greatly contribute to the reduction in thickness of a liquid crystal panel. The heat unevenness can be prevented by forming the thin second optical compensation layer. Further, such a thin optical compensation layer is preferred in terms of the prevention of disturbance of cholesteric alignment, decrease in transmittance, selective reflectivity, prevention of coloring, productivity, and the like.

The second optical compensation layer may have negative refractive index anisotropy, and an optical axis in a direction normal to a layer surface. For example, by using a non-liquid crystalline material described later, the second optical compensation layer may have negative refractive index anisotropy and an optical axis in a direction normal to a layer surface.

The second optical compensation layer in the present invention is formed of any suitable coating layer as long as the above thickness and optical properties are obtained. Preferably, examples of the second optical compensation layer include a cholesteric alignment fixed layer and a layer containing a non-liquid crystalline material.

A-3-2. Case where a Second Optical Compensation Layer is a Cholesteric Alignment Fixed Layer

The cholesteric alignment fixed layer is preferably a cholesteric alignment fixed layer with a wavelength range of selective reflection of 350 nm or less. The upper limit of the wavelength range of selective reflection is more preferably 320 nm or less, and most preferably 300 nm or less. On the other hand, the lower limit of the wavelength range of selective reflection is preferably 100 nm or more, and more preferably 150 nm or more. When the wavelength range of selective reflection exceeds 350 nm, the wavelength range of selective reflection falls in a visible light range, so the problems such as coloring and decoloring may arise. When the wavelength range of selective reflection is smaller than 100 nm, the amount of a chiral agent (described later) to be used becomes too large, so it is necessary to control a temperature during formation of an optical compensation layer very precisely. Consequently, it may be difficult to produce a liquid crystal panel.

The helical pitch of the cholesteric alignment fixed layer is preferably 0.01 to 0.25 μm, more preferably 0.03 to 0.20 μm, and most preferably 0.05 to 0.15 μm. When the helical pitch is 0.01 μm or more, for example, sufficient alignment is obtained. When the helical pitch is 0.25 μm or less, for example, optical rotation on a short wavelength side of visible light can be sufficiently suppressed, so light leakage and the like can be avoided sufficiently. The helical pitch can be controlled by adjusting the kind (distortion force) and amount of a chiral agent described later. By adjusting the helical pitch, the wavelength range of selective reflection can be controlled in a desired range.

In the case where the second optical compensation layer is formed of a cholesteric alignment fixed layer, the second optical compensation layer of the present invention is formed of any suitable material as long as the above thickness and optical properties are obtained. Preferably, the second optical compensation layer can be formed of a liquid crystal composition. As a liquid crystal material contained in the composition, any suitable liquid crystal material can be adopted. A liquid crystal material whose liquid crystal phase is a nematic phase (nematic liquid crystal) is preferred. As such a liquid crystal material, for example, a liquid crystal polymer and a liquid crystal monomer can be used. The expression mechanism of liquid crystallinity of a liquid crystal material may be a lyotropic mechanism or a thermotropic mechanism. Further, it is preferred that the alignment state of liquid crystal be homogeneous alignment.

The content of a liquid crystal material in the liquid crystal composition is preferably 75 to 95% by weight, and more preferably 80 to 90% by weight. In the case where the content of a liquid crystal material is less than 75% by weight, the composition does not exhibit a liquid crystal state sufficiently, and as a result, cholesteric alignment may not be formed sufficiently. In the case where the content of a liquid crystal material exceeds 95% by weight, the content of a chiral agent becomes small, and distortion cannot be provided sufficiently, and as a result, cholesteric alignment may not be formed sufficiently.

It is preferred that the above liquid crystal material be a liquid crystal monomer (for example, a polymerizable monomer and a cross-linking monomer). This is because, as described above, the alignment state of a liquid crystal monomer can be fixed by polymerizing or cross-linking liquid crystal monomers. If the liquid crystal monomers are polymerized or cross-linked after they are aligned, the alignment state can be fixed. A polymer is formed by polymerization, and a three-dimensional network structure is formed by cross-linking. In this case, the polymer is non-liquid crystalline. Thus, in the formed second optical compensation layer, for example, the transition to a liquid crystal phase, a glass phase, and a crystal phase due to the change in a temperature peculiar to a liquid crystalline compound does not occur. Consequently, the second optical compensation layer becomes an optical compensation layer much excellent in stability, which is not influenced by a change in temperature.

Any suitable liquid crystal monomers may be employed as the liquid crystal monomer. For example, there are used polymerizable mesogenic compounds and the like described in JP 2002-533742 A (WO 00/37585), EP 358208 (U.S. Pat. No. 5,211,877), EP 66137 (U.S. Pat. No. 4,388,453), WO 93/22397, EP 0261712, DE 19504224, DE 4408171, GB 2280445, and the like. Specific examples of the polymerizable mesogenic compounds include: LC242 (trade name) available from BASF Aktiengesellschaft; E7 (trade name) available from Merck & Co., Inc.; and LC-Silicone-CC3767 (trade name) available from Wacker-Chemie GmbH.

For example, a nematic liquid crystal monomer is preferred as the liquid crystal monomer, and a specific example thereof includes a monomer represented by the below-indicated formula (1). The liquid crystal monomer may be used alone or in combination of two or more thereof.

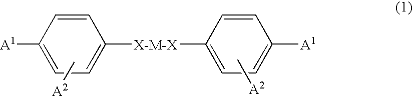

In the above formula (1), A¹ and A² each represent a polymerizable group, and may be the same or different from each other. One of A¹ and A² may represent hydrogen. Each X independently represents a single bond, —O—, —S—, —C═N—, —O—CO—, —CO—O—, —O—CO—O—, —CO—NR—, —NR—CO—, —NR—, —O—CO—NR—, —NR—CO—O—, —CH₂—O—, or —NR—CO—NR—. R represents H or an alkyl group having 1 to 4 carbon atoms. M represents a mesogen group.

In the above formula (1), Xs may be the same or different from each other, but are preferably the same.

Of monomers represented by the above formula (1), each A² is preferably arranged in an ortho position with respect to A¹.

A¹ and A² are preferably each independently represented by the below-indicated formula (2), and A¹ and A² preferably represent the same group.

Z-X-(Sp)ₙ (2)

In the above formula (2), Z represents a crosslinkable group, and X is the same as that defined in the above formula (1) Sp represents a spacer consisting of a substituted or unsubstituted linear or branched alkyl group having 1 to 30 carbon atoms. n represents 0 or 1. A carbon chain in Sp may be interrupted by oxygen in an ether functional group, sulfur in a thioether functional group, a non-adjacent imino group, an alkylimino group having 1 to 4 carbon atoms, or the like.

In the above formula (2), Z preferably represents any one of functional groups represented by the below-indicated formulae. In the below-indicated formulae, examples of R include a methyl group, an ethyl group, an n-propyl group, an i-propyl group, an n-butyl group, an i-butyl group, and a t-butyl group.

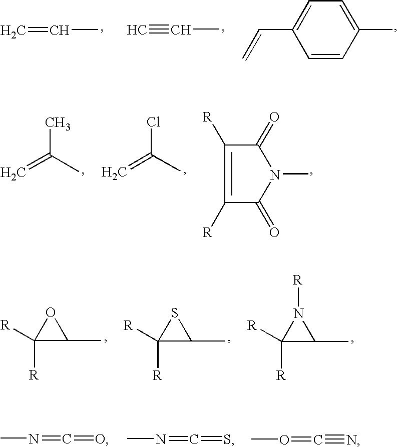

In the above formula (2), Sp preferably represents any one of structural units represented by the below-indicated formulae. In the below-indicated formulae, m preferably represents 1 to 3, and p preferably represents 1 to 12.

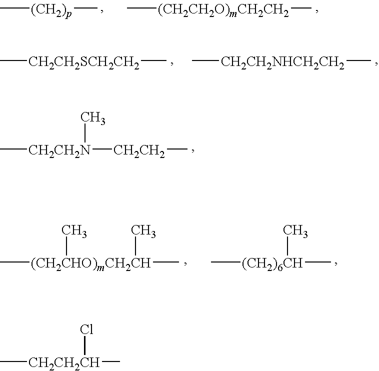

In the above formula (1), M is preferably represented by the below-indicated formula (3). In the below-indicated formula (3), X is the same as that defined in the above formula (1). Q represents a substituted or unsubstituted linear or branched alkylene group, or an aromatic hydrocarbon group, for example. Q may represent a substituted or unsubstituted linear or branched alkylene group having 1 to 12 carbon atoms, for example.

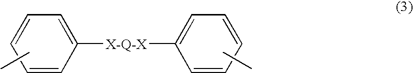

In the case where Q represents an aromatic hydrocarbon group, Q preferably represents anyone of aromatic hydrocarbon groups represented by the below-indicated formulae or substituted analogues thereof.

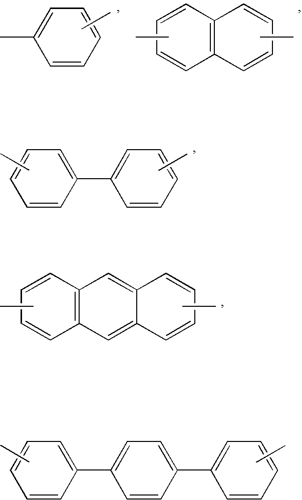

The substituted analogues of the aromatic hydrocarbon groups represented by the above formulae may each have 1 to 4 substituents per aromatic ring, or 1 to 2 substituents per aromatic ring or group. The substituents may be the same or different from each other. Examples of the substituents include: an alkyl group having 1 to 4 carbon atoms; a nitro group; a halogen group such as F, Cl, Br, or I; a phenyl group; and an alkoxy group having 1 to 4 carbon atoms.

Specific examples of the liquid crystal monomer include monomers represented by the following formulae (4) to (19).

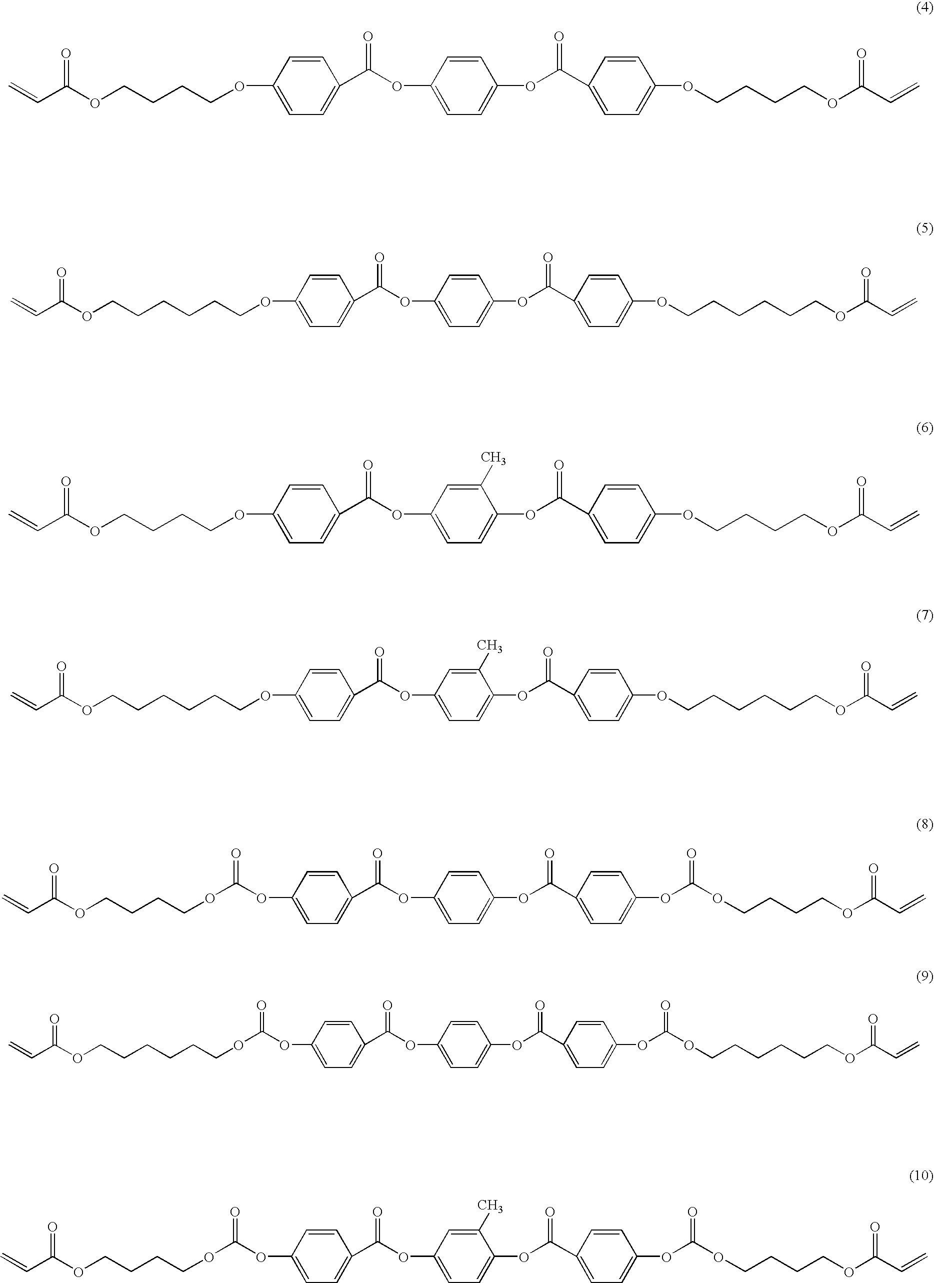

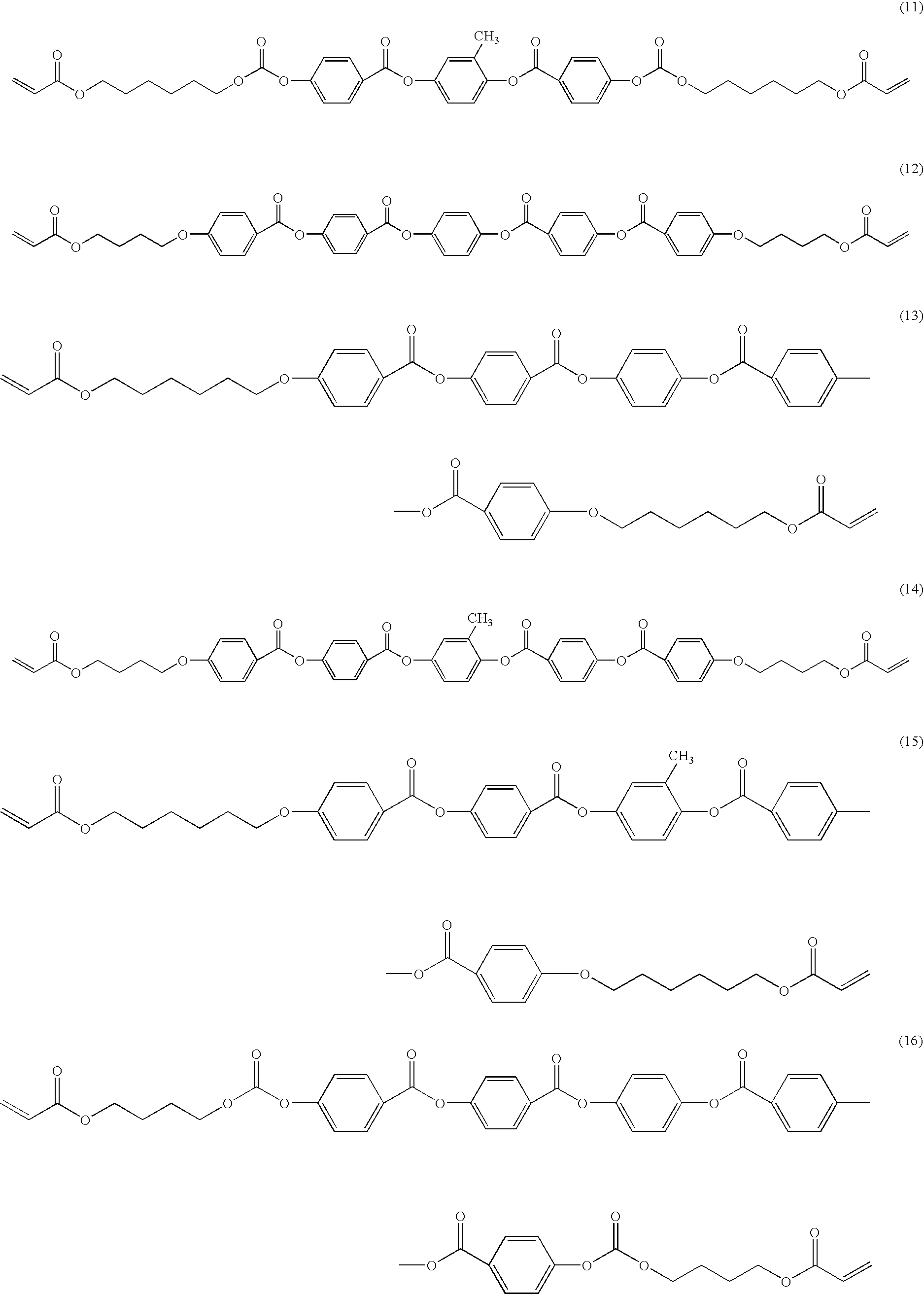

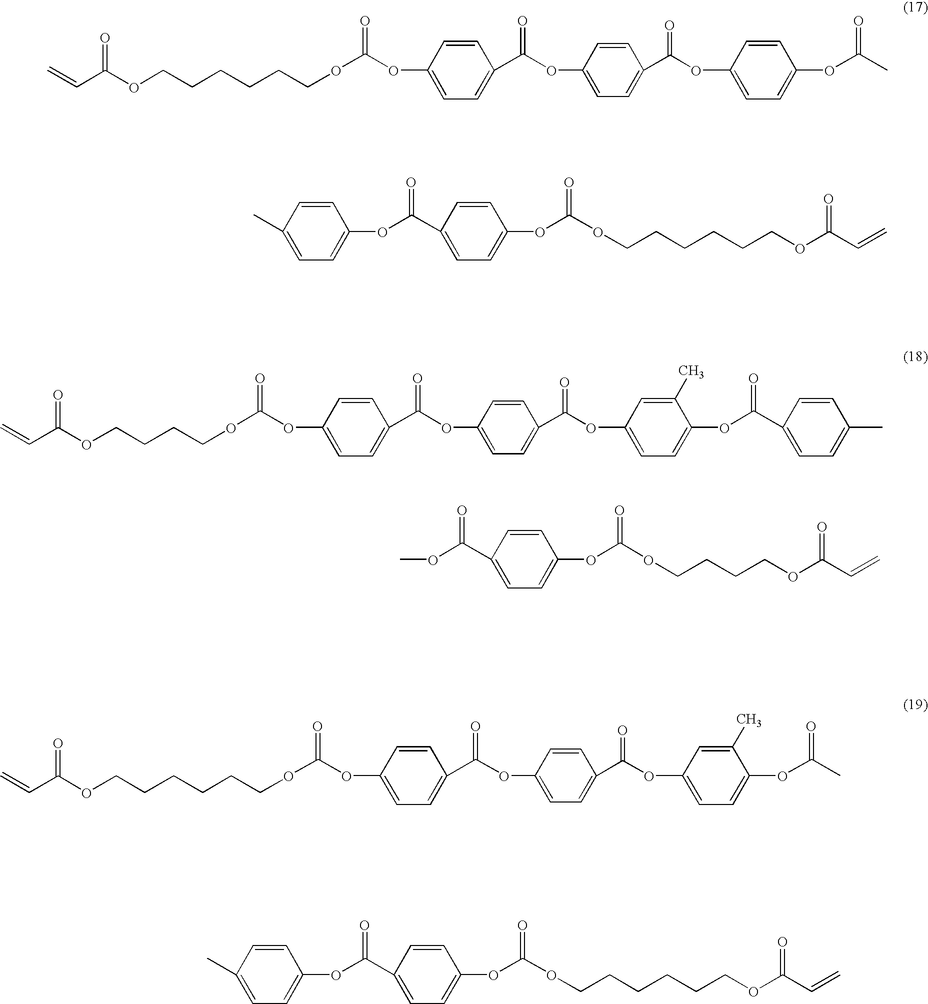

A temperature range in which the liquid crystal monomer exhibits liquid-crystallinity varies depending on the type of liquid crystal monomer. More specifically, the temperature range is preferably 40 to 120° C., more preferably 50 to 100° C., and most preferably 60 to 90° C.

Preferably, a liquid crystal composition capable of forming the second optical compensation layer (cholesteric alignment fixed layer) contains a chiral agent. By forming a second optical compensation layer of a composition containing a liquid crystalline monomer and a chiral agent, the difference between nx and nz can be set to be very large (nx>>nz). As a result, the second optical compensation layer can be rendered thin. For example, the negative C plate obtained by conventional biaxial stretching has a thickness of 60 μm or more, whereas the thickness of the second optical compensation layer used in the present invention can be decreased to about 1 to 2 μm if the layer is a single cholesteric alignment fixed layer. This can greatly contribute to the reduction in thickness of a liquid crystal panel.

The content of the chiral agent in the liquid crystal composition is preferably 5 to 23% by weight, and more preferably 10 to 20% by weight. In the case where the content is less than 5% by weight, a distortion is not provided sufficiently, so cholesteric alignment is not formed sufficiently. As a result, it may be difficult to control the wavelength range of selective reflection of an optical compensation layer to be obtained in a desired band (low wavelength side). In the case where the content exceeds 23% by weight, the temperature range in which a liquid crystal material exhibits a liquid crystal state becomes small, so it is necessary to control a temperature during formation of an optical compensation layer very precisely. As a result, it may become difficult to produce a second optical compensation layer. The chiral agent can be used alone or in combination.

As the chiral agent, any suitable material capable of aligning a liquid crystal material in a desired cholesteric structure can be adopted. For example, the distortion force of such a chiral agent is preferably 1×10⁻⁶ nm⁻¹·(wt %)⁻¹ or more, more preferably 1×10⁻⁵ nm⁻¹·(wt %)⁻¹ to 1×10⁻² nm⁻¹·(wt %)⁻¹, and most preferably 1×10⁻⁴ nm⁻¹·(wt %)⁻¹ to 1×10⁻³ nm⁻¹·(wt %)⁻¹. By using a chiral agent having such a distortion force, the helical pitch of the cholesteric alignment fixed layer can be controlled in a desired range, and consequently, the wavelength range of selective reflection can be controlled in a desired range. For example, in the case of using a chiral agent with the same distortion force, as the content of the chiral agent in the liquid crystal composition is larger, the wavelength range of selective reflection of an optical compensation layer to be formed is on a lower wavelength side. Further, for example, if the content of the chiral agent in the liquid crystal composition is the same, as the distortion force of the chiral agent is larger, the wavelength range of selective reflection of an optical compensation layer to be formed is on a lower wavelength side. More specific example is as follows. In the case of setting a wavelength range of selective reflection of an optical compensation layer to be formed in a range of 200 to 220 nm, for example, a chiral agent with distortion force of 5×10⁻⁴ nm⁻¹·(wt %)⁻¹ may be contained in a liquid crystal composition in an amount of 11 to 13% by weight. In the case of setting the wavelength range of selective reflection of an optical compensation layer to be formed in a range of 290 to 310 nm, for example, a chiral agent with a distortion force of 5×10⁻⁴ nm⁻¹·(wt %)⁻¹ may be contained in a liquid crystal composition in an amount of 7 to 9% by weight.

The chiral agent is preferably a polymerizable chiral agent. Specific examples of the polymerizable chiral agent include chiral compounds represented by the following general formulae (20) to (23).

(Z-X⁵)ₙCh (20)

(Z-X²-Sp-X⁵)ₙCh (21)

(P¹—X⁵)ₙCh (22)

(Z-X²-Sp-X³-M-X⁴)ₙCh (23)

In the formulae (20) to (23), Z and Sp are the same as those defined for the above formula (2). X², X³, and X⁴ each independently represent a chemical single bond, —O—, —S—, —O—CO—, —CO—O—, —O—CO—O—, —CO—NR—, —NR—CO—, —O—CO—NR—, —NR—CO—O—, or —NR—CO—NR—. R represents H or an alkyl group having 1 to 4 carbon atoms. X⁵ represents a chemical single bond, —O—, —S—, —O—CO—, —CO—O—, —O—CO—O—, —CO—NR—, —NR—CO—, —O—CO—NR—, —NR—CO—O—, —NR—CO—NR—, —CH₂O—, —O—CH₂—, —CH═N—, —N═CH—, or —N≡N—. R represents H or an alkyl group having 1 to 4 carbon atoms as described above. M represents a mesogenic group as described above. P¹ represents hydrogen, an alkyl group having 1 to 30 carbon atoms, an acyl group having 1 to 30 carbon atoms, or a cycloalkyl group having 3 to 8 carbon atoms which is substituted by 1 to 3 alkyl groups having 1 to 6 carbon atoms. n represents an integer of 1 to 6. Ch represents a chiral group with a valence of n. In the formula (23), at least one of X³ and X⁴ preferably represents —O—CO—O—, —O—CO—NR—, —NR—CO—O—, or —NR—CO—NR—. In the formula (22), in the case where P¹ represents an alkyl group, an acyl group, or a cycloalkyl group, its carbon chain may be interrupted by oxygen of an ether functional group, sulfur of a thioether functional group, a non-adjacent imino group, or an alkyl imino group having 1 to 4 carbon atoms.

Examples of the chiral group represented by Ch include atomic groups represented by the following formulae.

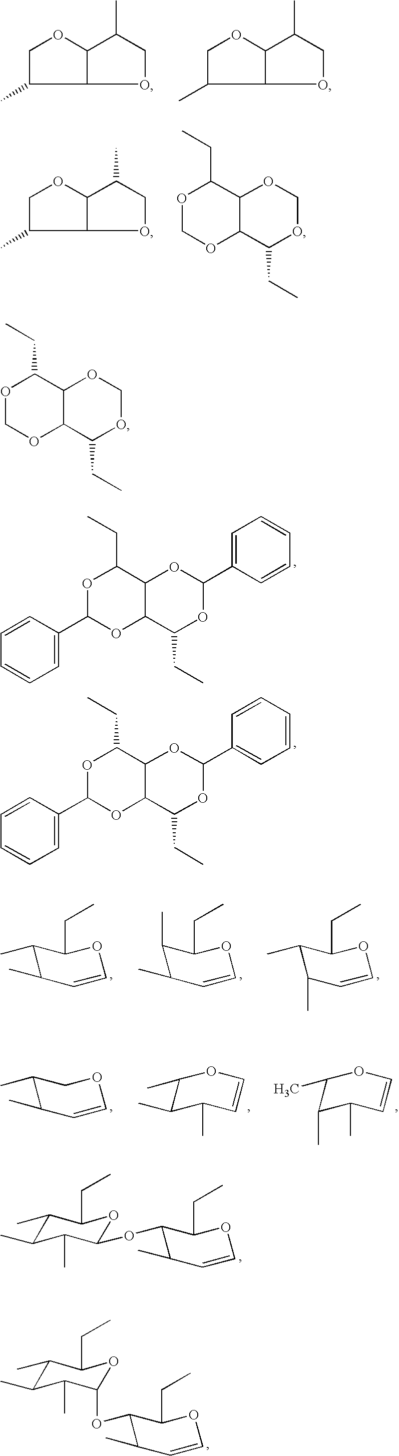

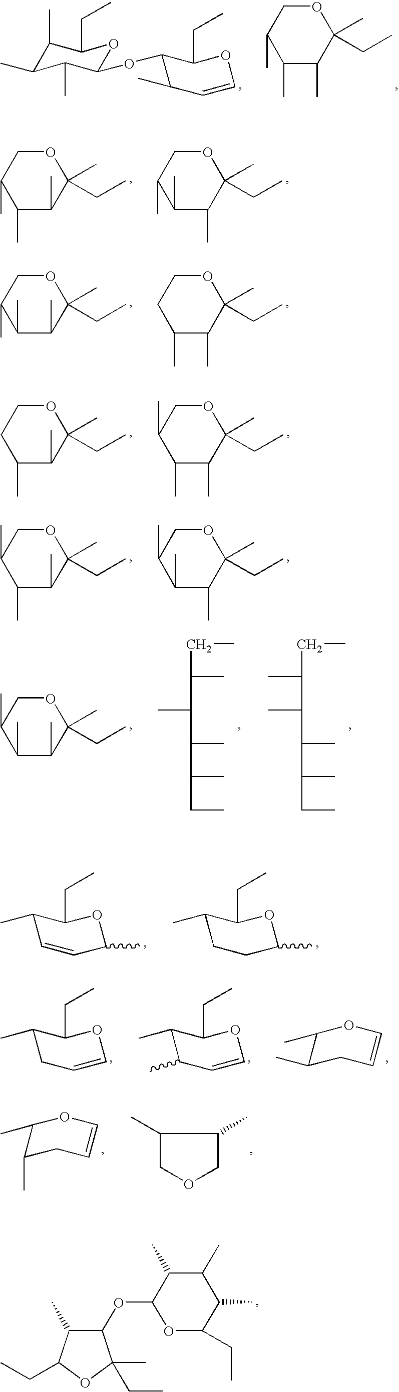

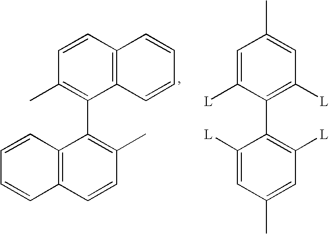

In the atomic groups described above, L represents an alkyl group having 1 to 4 carbon atoms, an alkoxy group having 1 to 4 carbon atoms, a halogen, COOR, OCOR, CONHR, or NHCOR. R represents an alkyl group having 1 to 4 carbon atoms. Note that terminals of the atomic groups represented in the above formulae each represent a bonding hand to an adjacent group.

Of the atomic groups, atomic groups represented by the following formulae are particularly preferred.

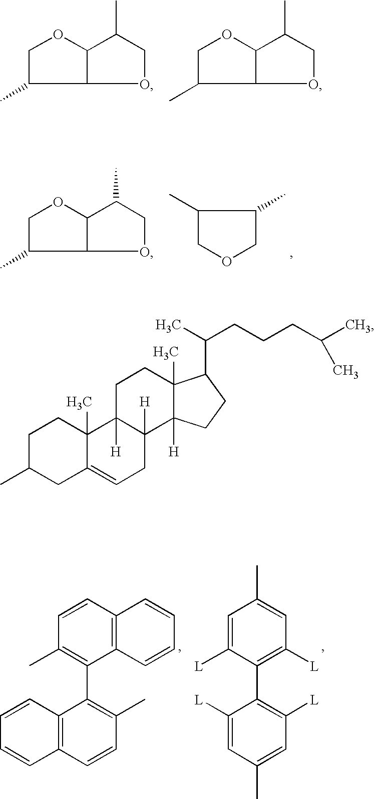

In a preferred example of the chiral compound represented by the above formula (21) or (23): n represents 2; Z represents H₂C═CH—; and Ch represents atomic groups represented by the following formulae.

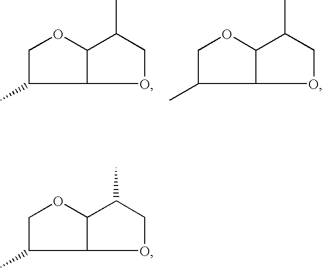

Specific examples of the chiral compound include compounds represented by the following formulae (24) to (44). Note that those chiral compounds each have a torsional force of 1×10⁻⁶ nm⁻¹·(wt %)⁻¹ or more.

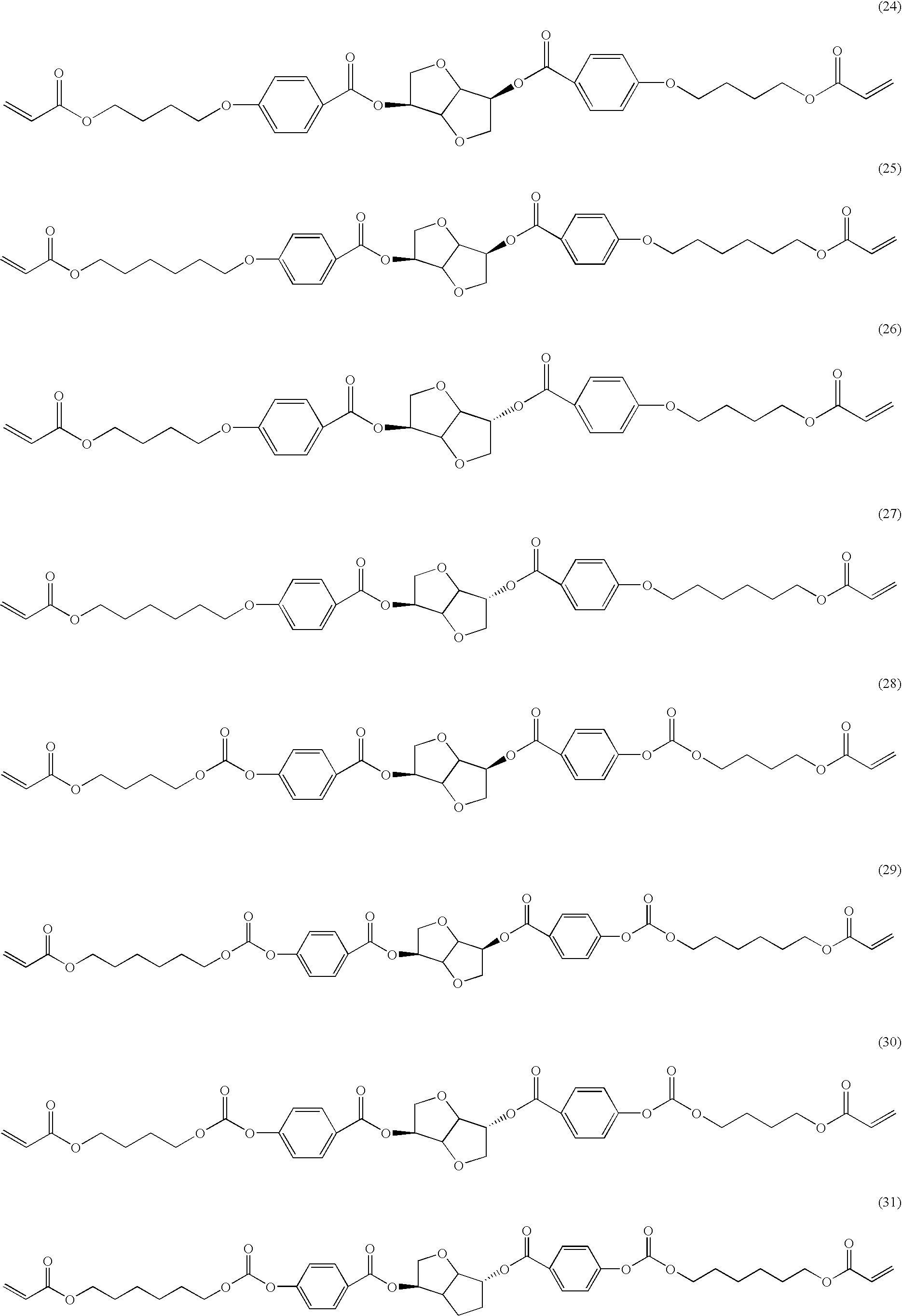

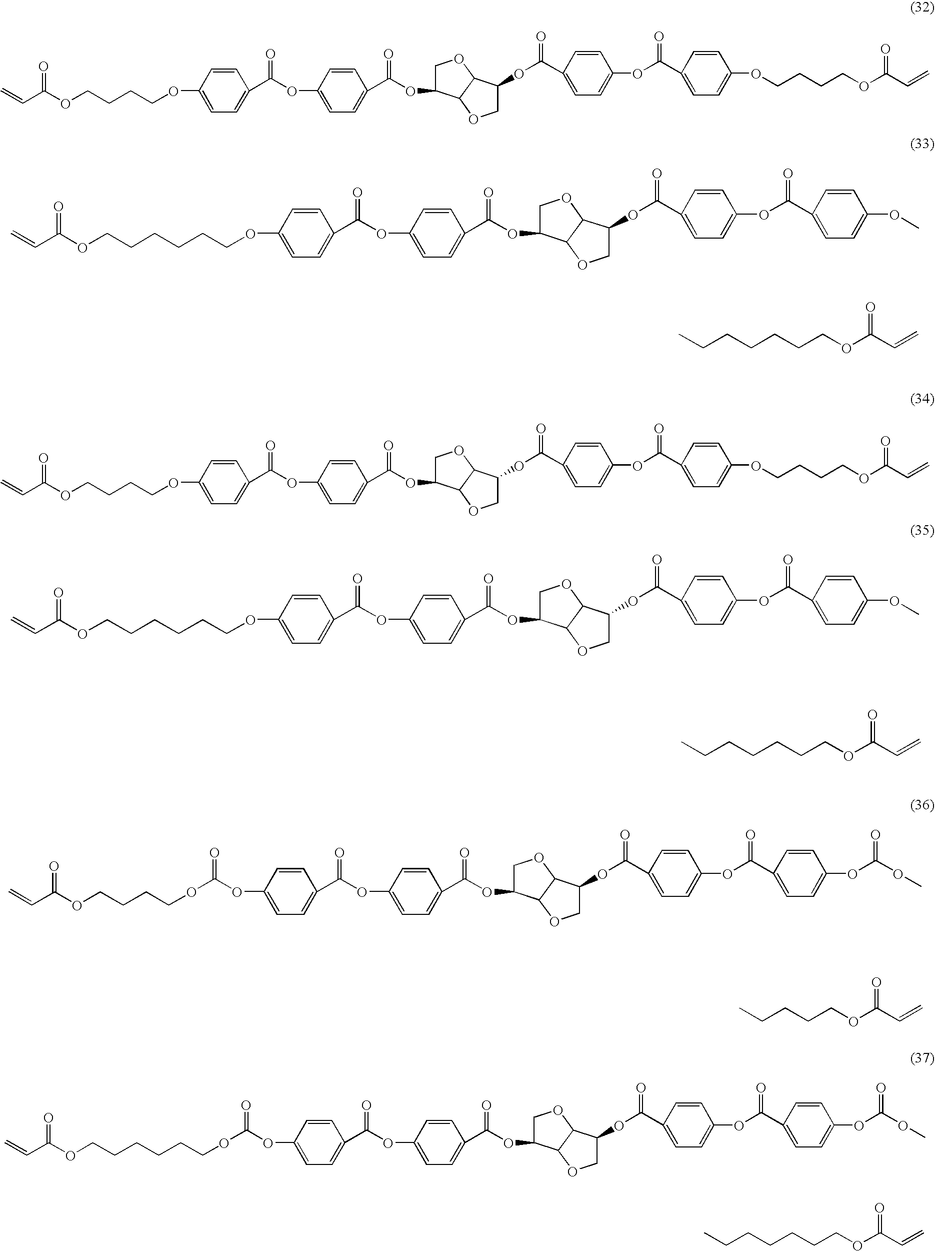

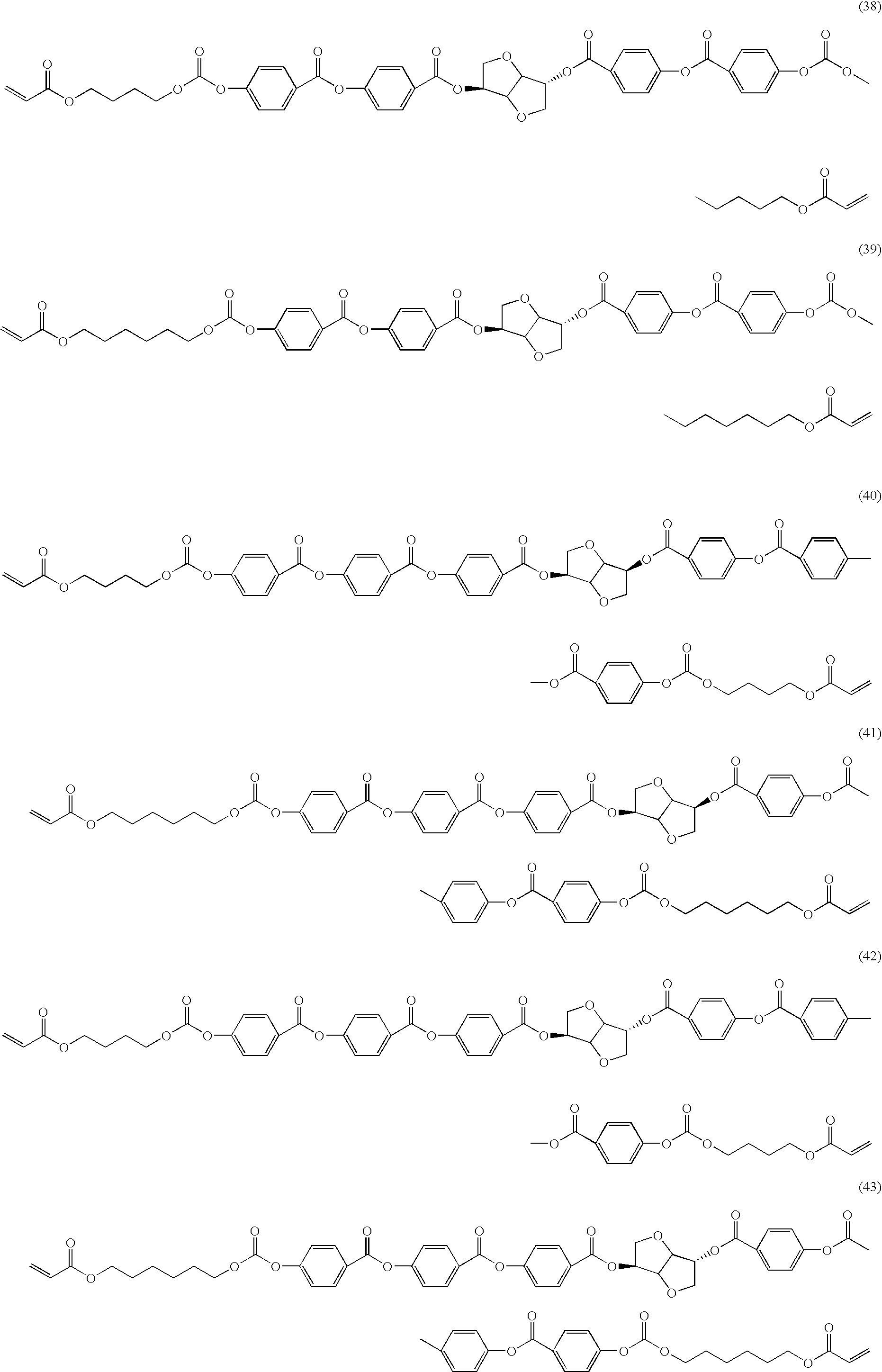

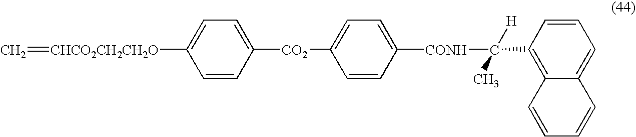

In addition to the chiral compounds represented above, further examples of the chiral compound include chiral compounds described in RE-A4342280, DE 19520660.6, and DE 19520704.1.

Note that any appropriate combination of the liquid crystal material and the chiral agent may be employed in accordance with the purpose. Particularly typical examples of the combination include: a combination of the liquid crystal monomer represented by the above formula (10)/the chiral agent represented by the above formula (32); a combination of the liquid crystal monomer represented by the above formula (10)/the chiral agent represented by the above formula (38); and a combination of the liquid crystal monomer represented by the above formula (11)/the chiral agent represented by the above formula (39).

Preferably, a liquid crystal composition capable of forming the second optical compensation layer further contains at least one of a polymerization initiator and a cross-linking agent (curing agent). By using the polymerization initiator and/or cross-linking agent (curing agent), a cholesteric structure (cholesteric alignment) formed while a liquid crystal material is in a liquid crystal state can be fixed. Any appropriate substance may be used for the polymerization initiator or the cross-linking agent as long as the effect of the present invention can be obtained. Examples of the polymerization initiator include benzoylperoxide (BPO) and azobisisobutyronitrile (AIBN). Examples of the cross-linking agent (curing agent) include a UV-curing agent, a photo-curing agent, and a thermosetting agent. Specific examples thereof include an isocyanate-based cross-linking agent, an epoxy-based cross-linking agent, and a metal chelate cross-linking agent. They may be used alone or in combination. A content of the polymerization initiator or the cross-linking agent in the liquid crystal composition is preferably 0.1 to 10 wt %, more preferably 0.5 to 8 wt %, and most preferably 1 to 5 wt %. In the case where the content of the polymerization initiator or the cross-linking agent is less than 0.1 wt %, the fixation of the chlorestic structure may be insufficient. In the case where the content of the polymerization initiator or the cross-linking agent is more than 10 wt %, the liquid crystal material exhibits a liquid crystal state in a very narrow temperature range and temperature control during formation of the chlorestic structure during the formation of chlorestic structure may involve difficulties.

The liquid crystal composition may contain another appropriate additive as required. Examples of the additive include an antioxidant, a modifier, a surfactant, a dye, a pigment, a color protection agent, and a UV absorber. They may be used alone or in combination. Specific examples of the antioxidant include a phenol-based compound, an amine-based compound, an organic sulfur-based compound, and a phosphine-based compound. Examples of the modifier include glycols, silicones, and alcohols. The surfactant is added for smoothing a surface of an optical compensation layer. Examples of the surfactant that can be used include a silicone-based surfactant, an acrylic surfactant, and a fluorine-based surfactant, and a particularly preferred example thereof is a silicon-based surfactant.

As a method of forming the second optical compensation layer (cholesteric alignment fixed layer), any suitable method can be adopted as long as a desired cholesteric alignment fixed layer is obtained. A typical method of forming a second optical compensation layer (cholesteric alignment fixed layer) includes: the step of spreading the liquid crystal composition on a base material to form a spread layer (coating film); the step of subjecting the spread layer to heating treatment so that the liquid crystal material in the liquid crystal composition has cholesteric alignment; the step of subjecting the spread layer to at least one of polymerization and cross-linking treatments to fix the alignment of the liquid crystal material; and the step of transferring the cholesteric alignment fixed layer formed on the base material. Hereinafter, a specific procedure of the formation method will be described.

First, a liquid crystal material, a chiral agent, a polymerization initiator or a cross-linking agent, and various kinds of additives if required, are dissolved or dispersed in a solvent to prepare a liquid crystal application liquid (liquid crystal composition). The liquid crystal material, the chiral agent, the polymerization initiator, the cross-linking agent, and the additives are as described above. The solvent to be used for a liquid crystal application liquid is not particularly limited. Specific examples include: halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, methoxybenzene, 1,2-dimethoxybenzene, and mesitylene; ketone-based solvents such as acetone, methyl ethyl ketone (MEK), methyl isobutyl ketone, cyclohexanone, cyclopentanone, 2-pyrrolidone, and N-methyl-2-pyrrolidone; ester-based solvents such as ethyl acetate, propyl acetate, and butyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide-based solvents such as dimethylformamide and dimethylacetamide; nitrile-based solvents such as acetonitrile and butyronitrile; ether-based solvents such as diethyl ether, dibutyl ether, tetrahydrofuran, and dioxane; carbon disulfide; and cellosolves such as ethyl cellosolve, butyl cellosolve, and ethylcellosolve acetate. Of those, toluene, xylene, mesitylene, MEK, methyl isobutyl ketone, cyclohexanone, ethyl cellosolve, butyl cellosolve, ethyl cellosolve acetate, ethyl acetate, propyl acetate, and butyl acetate are preferred. The solvent may be used alone or in combination.

The viscosity of liquid crystal application liquid may vary depending on the content of the above liquid crystal material and a temperature. For example, when the concentration of the liquid crystal material at nearly room temperature (20 to 30° C.) is 5 to 70 wt %, the viscosity of the application liquid is preferably 0.2 to 20 mPa·s, more preferably 0.5 to 15 mPa·s, or most preferably 1 to 10 mPa·s. To be additionally specific, when the concentration of the liquid crystal material is 30 wt % in the liquid crystal application liquid, the viscosity of the application liquid is preferably 2 to 5 mPa·s, or more preferably 3 to 4 mPa·s. When the viscosity of the application liquid is 0.2 mPa·s or more, the occurrence of a liquid flow due to the travelling of the application liquid can be prevented in an extremely favorable manner. In addition, when the viscosity of the application liquid is 20 mPa·s or less, an optical compensation layer having no thickness unevenness and having extremely excellent surface smoothness can be obtained, and, further, the application liquid is excellent in application property.

Next, the liquid crystal application liquid is applied onto the base material to form a development layer. Any appropriate method (typically, a method involving fluidly developing the application liquid containing the liquid crystal composition) can be adopted as a method of forming the development layer. Specific examples thereof include a roll coating, spin coating, wire bar coating, dip coating, extrusion, curtain coating, and spray coating. Of those, spin coating and extrusion coating are preferred in view of application efficiency.

An application amount of the liquid crystal application liquid may be appropriately determined depending on a concentration of the application liquid, the thickness of the target layer, and the like. For example, when the concentration of the liquid crystal material is 20 wt % in the application liquid, the application amount is preferably 0.03 to 0.17 ml, more preferably 0.05 to 0.15 ml, and most preferably 0.08 to 0.12 ml per an area of the base material (100 cm²).

Any appropriate base material capable of aligning the liquid crystal material can be adopted as the base material. Any appropriate plastic may be used. As a plastic for use in any such film, any appropriate plastic film can be used. Examples thereof include triacetylcellulose (TAC), a polyolefin such as polyethylene, polypropylene, or a poly(4-methylpentene-1), polyimide, polyimideamide, polyetherimide, polyamide, polyether ether ketone, polyetherketone, polyketone sulfide, polyethersulfone, polysulfone, polyphenylene sulfide, polyphenylene oxide, polyethylene terephthalate, polybutylene terephthalate, polyethylene naphthalate, polyacetal, polycarbonate, polyallylate, an acrylic resin, polyvinyl alcohol, polypropylene, a cellulose-based plastic, an epoxy resin, and a phenol resin. Alternatively, a product obtained by placing such plastic film or sheet as described above on the surface of, for example, a base material made of a metal such as aluminum, copper, or iron, a ceramic base material, or a glass base material can also be used. Alternatively, a product obtained by forming an SiO₂ oblique deposited film on the surface of the base material, or of the plastic film or sheet can also be used. The base material has a thickness of preferably 5 to 500 μm, more preferably 10 to 200 μm, or most preferably 15 to 150 μm. Such thickness can provide the base material with sufficient strength, and hence can prevent the occurrence of a problem such as the rupture of the base material at the time of the production of the liquid crystal panel.

Next, the spread layer is subjected to a heat treatment so that the above liquid crystal material is aligned to show a liquid crystal phase. The spread layer is provided with distortion and aligned to show a liquid crystal phase because the liquid crystal composition contains the chiral agent as well as the liquid crystal material. As a result, the spread layer (composed of the liquid crystal material) shows a cholesteric structure (helical structure).

The temperature condition of the heating treatment can be set appropriately depending upon the kind (specifically, the temperature at which a liquid crystal material exhibits liquid crystallinity) of the liquid crystal material. More specifically, the heating temperature is preferably 40 to 120° C., more preferably 50 to 100° C., and most preferably 60 to 90° C. If the heating temperature is 40° C. or more, a liquid crystal material can be generally aligned sufficiently. If the heating temperature is 120° C. or less, for example, the choice of a base material in the case of considering heat resistance is enlarged, so an optimum base material in accordance with a liquid crystal material can be selected. Further, the heating time is preferably 30 seconds or more, more preferably 1 minute or more, particularly preferably 2 minutes or more, and most preferably 4 minutes or more. In the case where the treatment time is less than 30 seconds, a liquid crystal material may not assume a sufficient liquid crystal state. On the other hand, the heating time is preferably 10 minutes or less, more preferably 8 minutes or less, and most preferably 7 minutes or less. When the treatment time exceeds 10 minutes, an additive may be sublimated.

Next, the alignment (cholesteric structure) of the liquid crystal material is fixed by subjecting the spread layer to a polymerization treatment or a cross-linking treatment in a state where the above liquid crystal composition shows a cholesteric structure. To be additionally specific, performing the polymerization treatment causes the above liquid crystal material (polymerizable monomer) and/or the chiral agent (polymerizable chiral agent) to polymerize, and causes the polymerizable monomer and/or the polymerizable chiral agent to be fixed as a repeating unit of a polymer molecule. In addition, performing the cross-linking treatment causes at least one of the above liquid crystal material (cross-linking monomer) and/or the chiral agent to form a three-dimensional network structure, and causes the cross-linking monomer and/or the chiral agent to be fixed as part of a cross-linked structure. As a result, the alignment state of the liquid crystal material is fixed. It should be noted that a polymer or three-dimensional network structure formed by the polymerization or cross-linking of the liquid crystal material is “non-liquid crystalline”, and hence does not undergo any transition to a liquid crystal phase, a glass phase, or a crystalline phase owing to, for example, a temperature change peculiar to a liquid crystal molecule in a formed second optical compensation layer. Therefore, no alignment change due to a temperature occurs. As a result, the formed second optical compensation layer can be used as a high-performance optical compensation layer that is not influenced by a temperature. Further, the second optical compensation layer can significantly suppress light leakage and the like because its wavelength range of selective reflection is optimized in the range of 100 nm to 320 nm.

A specific procedure for the above polymerization treatment or cross-linking treatment can be appropriately selected depending on the kind of a polymerization initiator or cross-linking agent to be used. For example, when a photopolymerization initiator or a photoinitiator cross-linking agent is used, irradiation with light has only to be performed, when a ultraviolet polymerization initiator or a ultraviolet cross-linking agent is used, irradiation with ultraviolet light has only to be performed, and when a polymerization initiator or a cross-linking agent is used by heat, heating has only to be performed. The time period for irradiation with light or ultraviolet light, the irradiation intensity of light or ultraviolet light, the total quantity of light or ultraviolet light, and the like can be appropriately set depending on the kind of the liquid crystal material, the kind of the base material, desired characteristics for the second optical compensation layer, and the like. In a similar manner, the heating temperature, the time period for heating, and the like can be appropriately set depending on purposes.

The cholesteric alignment fixed layer thus formed on the base material is transferred to the surface of a first optical compensation layer 12 via an adhesive layer 13 to become a second optical compensation layer 14. The transfer further includes the step of peeling the base material from the second optical compensation layer. The thickness of the adhesive layer 13 is preferably 0.1 to 20 μm, more preferably 0.5 to 15 μm, and still more preferably 1 to 10 μm.

In the above typical example of the method of forming a second optical compensation layer, a liquid crystal monomer (for example, a polymerizable monomer or a cross-linking monomer) is used as a liquid crystal material. However, in the present invention, the method of forming a second optical compensation layer is not limited to such a method, and a method of using a liquid crystal polymer may be used. The method using a liquid crystal monomer as described is preferred. By using a liquid crystal monomer, a thinner optical compensation layer having a more excellent optical compensation function can be formed. Specifically, if the liquid crystal monomer is used, the wavelength range of selective reflection can be controlled more easily. Further, because it is easy to set the viscosity of an application liquid and the like, a thin second optical compensation layer can be formed more easily, and the handling thereof is very excellent. In addition, the surface flatness of an optical compensation layer to be obtained is more excellent.

A-3-3. Case where a Second Optical Compensation Layer Contains a Non-Liquid Crystalline Material

In the case where the second optical compensation layer contains a non-liquid crystalline material, the second optical compensation layer of the present invention can adopt any suitable material as long as the above thickness and optical properties are obtained. For example, as such a material, there is a non-liquid crystalline material. A non-liquid crystalline polymer is particularly preferred. Unlike a liquid crystalline material, such a non-liquid crystalline material can form a film exhibiting an optical uniaxial properties of nx>nz and ny>nz due to properties thereof irrespective of the alignment of the substrate. Consequently, a non-aligned substrate as well as an aligned substrate can be used. Further, even in the case of using a non-aligned substrate, the step of coating an alignment film to the surface thereof, the step of laminating an alignment film, and the like can be omitted.

A preferred example of the non-liquid crystalline material includes a polymer such as polyamide, polyimide, polyester, polyetherketone, polyamideimide, or polyesterimide since such a material has excellent thermal resistance, excellent chemical resistance, excellent transparency, and sufficient rigidity. One type of polymer may be used, or a mixture of two or more types thereof having different functional groups such as a mixture of polyaryletherketone and polyamide may be used. Of those, polyimide is particularly preferred in view of high transparency, high alignment ability, and high extension.

A molecular weight of the polymer is not particularly limited. However, the polymer has a weight average molecular weight (Mw) of preferably within a range of 1,000 to 1,000,000, more preferably within a range of 2,000 to 500,000, for example.

Polyimide which has high in-plane alignment ability and which is soluble in an organic solvent is preferred as polyimide used in the present invention, for example. More specifically, a polymer disclosed in JP 2000-511296 A, containing a condensation polymerization product of 9,9-bis(aminoaryl) fluorene and aromatic tetracarboxylic dianhydride, and containing at least one repeating unit represented by the following formula (45) can be used.

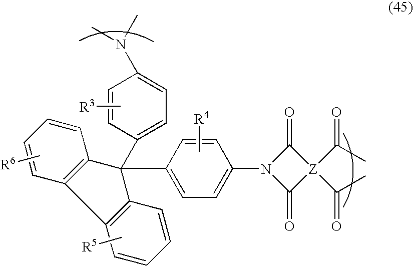

In the above formula (45), R³ to R⁶ independently represent at least one type of substituent selected from hydrogen, a halogen, a phenyl group, a phenyl group substituted with 1 to 4 halogen atoms or 1 to 4 alkyl groups each having 1 to 10 carbon atoms, and an alkyl group having 1 to 10 carbon atoms. Preferably, R³ to R⁶ independently represent at least one type of substituent selected from a halogen, a phenyl group, a phenyl group substituted with 1 to 4 halogen atoms or 1 to 4 alkyl groups each having 1 to 10 carbon atoms, and an alkyl group having 1 to 10 carbon atoms.

In the above formula (45), Z represents a tetravalent aromatic group having 6 to 20 carbon atoms, and preferably represents a pyromellitic group, a polycyclic aromatic group, a derivative of the polycyclic aromatic group, or a group represented by the following formula (46), for example.

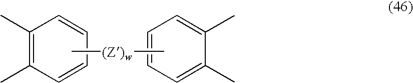

In the above formula (46), Z′ represents a covalent bond, a C(R⁷)₂ group, a CO group, an O atom, an S atom, an SO₂ group, an Si (C₂H₅) 2 group, or an NR⁸ group. A plurality of Z′s may be the same or different from each other. w represents an integer of 1 to 10. R⁷s independently represent hydrogen or a C(R⁹)₃ group. R⁸ represents hydrogen, an alkyl group having 1 to about 20 carbon atoms, or an aryl group having 6 to 20 carbon atoms. A plurality of R⁸s may be the same or different from each other. R⁹s independently represent hydrogen, fluorine, or chlorine.

An example of the polycyclic aromatic group includes a tetravalent group derived from naphthalene, fluorene, benzofluorene, or anthracene. An example of the substituted derivative of the polycyclic aromatic group includes the above polycyclic aromatic group substituted with at least a group selected from an alkyl group having 1 to 10 carbon atoms, a fluorinated derivative thereof, and a halogen such as F or Cl.

Other examples of the polyimide include: a homopolymer disclosed in JP 08-511812 A and containing a repeating unit represented by the following general formula (47) or (48); and polyimide disclosed therein and containing a repeating unit represented by the following general formula (49). Note that, polyimide represented by the following formula (49) is a preferred form of the homopolymer represented by the following formula (47).

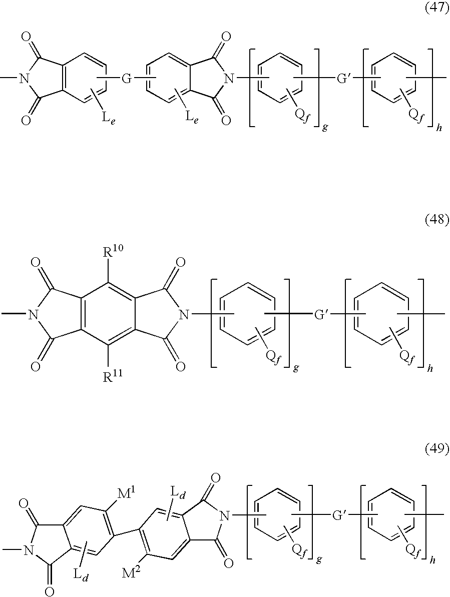

In the above general formulae (47) to (49), G and G′ independently represent a covalent bond, a CH₂ group, a C(CH₃) 2 group, a C(CF₃)₂ group, a C(CX₃)₂ group (wherein, X represents a halogen), a CO group, an O atom, an S atom, an SO₂ group, an Si(CH₂CH₃)₂ group, or an N(CH₃) group, for example. G and G′ may be the same or different from each other.

In the above formulae (47) and (49), L is a substituent, and d and e each represent the number of the substituents. L represents a halogen, an alkyl group having 1 to 3 carbon atoms, a halogenated alkyl group having 1 to 3 carbon atoms, a phenyl group, or a substituted phenyl group, for example. A plurality of Ls may be the same or different from each other. An example of the substituted phenyl group includes a substituted phenyl group having at least one type of substituent selected from a halogen, an alkyl group having 1 to 3 carbon atoms, and a halogenated alkyl group having 1 to 3 carbon atoms, for example. Examples of the halogen include fluorine, chlorine, bromine, and iodine. d represents an integer of 0 to 2, and e represents an integer of 0 to 3.

In the above formulae (47) to (49), Q is a substituent, and f represents the number of the substituents. Q represents an atom or a group selected from hydrogen, a halogen, an alkyl group, a substituted alkyl group, a nitro group, a cyano group, a thioalkyl group, an alkoxy group, an aryl group, a substituted aryl group, an alkyl ester group, and a substituted alkyl ester group, for example. A plurality of Qs may be the same or different from each other. Examples of the halogen include fluorine, chlorine, bromine, and iodine. An example of the substituted alkyl group includes a halogenated alkyl group. An example of the substituted aryl group includes a halogenated aryl group. f represents an integer of 0 to 4, and g represents an integer of 0 to 3. h represents an integer of 1 to 3. g and h are each preferably larger than 1.

In the above formula (48), R¹⁰ and R¹¹ independently represent an atom or a group selected from hydrogen, a halogen, a phenyl group, a substituted phenyl group, an alkyl group, and a substituted alkyl group. Preferably, R¹⁰ and R¹¹ independently represent a halogenated alkyl group.

In the above formula (49), M¹ and M² independently represent a halogen, an alkyl group having 1 to 3 carbon atoms, a halogenated alkyl group having 1 to 3 carbon atoms, a phenyl group, or a substituted phenyl group, for example. Examples of the halogen include fluorine, chlorine, bromine, and iodine. An example of the substituted phenyl group includes a substituted phenyl group having at least one type of substituent selected from the group consisting of a halogen, an alkyl group having 1 to 3 carbon atoms, and a halogenated alkyl group having 1 to 3 carbon atoms.

A specific example of the polyimide represented by the above formula (47) includes a compound represented by the following formula (50).

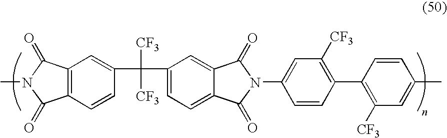

Another example of the polyimide includes a copolymer prepared through arbitrary copolymerization of acid dianhydride having a skeleton (repeating unit) other than that as described above and diamine.

An example of the acid dianhydride includes an aromatic tetracarboxylic dianhydride. Examples of the aromatic tetracarboxylic dianhydride include pyromellitic dianhydride, benzophenone tetracarboxylic dianhydride, naphthalene tetracarboxylic dianhydride, heterocyclic aromatic tetracarboxylic dianhydride, and 2,2′-substituted biphenyltetracarboxylic dianhydride.

Examples of the pyromellitic dianhydride include: pyromellitic dianhydride; 3,6-diphenyl pyromellitic dianhydride; 3,6-bis(trifluoromethyl)pyromellitic dianhydride; 3,6-dibromopyromellitic dianhydride; and 3,6-dichloropyromellitic dianhydride. Examples of the benzophenone tetracarboxylic dianhydride include: 3,3′,4,4′-benzophenone tetracarboxylic dianhydride; 2,3,3′,4′-benzophenone tetracarboxylic dianhydride; and 2,2′,3,3′-benzophenone tetracarboxylic dianhydride. Examples of the naphthalene tetracarboxylic dianhydride include: 2,3,6,7-naphthalene tetracarboxylic dianhydride; 1,2,5,6-naphthalene tetracarboxylic dianhydride; and 2,6-dichloronaphthalene-1,4,5,8-tetracarboxylic dianhydride. Examples of the heterocyclic aromatic tetracarboxylic dianhydride include: thiophene-2,3,4,5-tetracarboxylic dianhydride; pyrazine-2,3,5,6-tetracarboxylic dianhydride; and pyridine-2,3,5,6-tetracarboxylic dianhydride. Examples of the 2,2′-substituted biphenyltetracarboxylic dianhydride include: 2,2′-dibromo-4,4′,5,5′-biphenyltetracarboxylic dianhydride; 2,2′-dichloro-4,4′,5,5′-biphenyltetracarboxylic dianhydride; and 2,2′-bis(trifluoromethyl)-4,4′,5,5′-biphenyltetracarboxylic dianhydride.

Further examples of the aromatic tetracarboxylic dianhydride include: 3,3′,4,4′-biphenyltetracarboxylic dianhydride; bis(2,3-dicarboxyphenyl)methane dianhydride; bis(2,5,6-trifluoro-3,4-dicarboxyphenyl)methane dianhydride; 2,2-bis(3,4-dicarboxyphenyl)-1,1,1,3,3,3-hexafluoropropane dianhydride; 4,4′-bis(3,4-dicarboxyphenyl)-2,2-diphenylpropane dianhydride; bis(3,4-dicarboxyphenyl)ether dianhydride; 4,4′-oxydiphthalic dianhydride; bis(3,4-dicarboxyphenyl) sulfonic dianhydride; 3,3′,4,4′-diphenylsulfone tetracarboxylic dianhydride; 4,4′-[4,4′-isopropylidene-di(p-phenyleneoxy)]bis(phthalic anhydride); N,N-(3,4-dicarboxyphenyl)-N-methylamine dianhydride; and bis(3,4-dicarboxyphenyl)diethylsilane dianhydride.

Of those, the aromatic tetracarboxylic dianhydride is preferably 2,2′-substituted biphenyltetracarboxylic dianhydride, more preferably 2,2′-bis(trihalomethyl)-4,4′,5,5′-biphenyltetracarboxylic dianhydride, and furthermore preferably 2,2′-bis(trifluoromethyl)-4,4′,5,5′-biphenyltetracarboxylic dianhydride.

An example of the diamine includes aromatic diamine. Specific examples of the aromatic diamine include benzenediamine, diaminobenzophenone, naphthalenediamine, heterocyclic aromatic diamine, and other aromatic diamines.

Examples of the benzenediamine include benzenediamines such as o-, m-, or p-phenylenediamine, 2,4-diaminotoluene, 1,4-diamino-2-methoxybenzene, 1,4-diamino-2-phenylbenzene, and 1,3-diamino-4-chlorobenzene. Examples of the diaminobenzophenone include 2,2′-diaminobenzophenone and 3,3′-diaminobenzophenone. Examples of the naphthalenediamine include 1,8-diaminonaphthalene and 1,5-diaminonaphthalene. Examples of the heterocyclic aromatic diamine include 2,6-diaminopyridine, 2,4-diaminopyridine, and 2,4-diamino-5-triazine.

Further examples of the aromatic diamine include: 4,4′-diaminobiphenyl; 4,4′-diaminodiphenylmethane; 4,4′-(9-fluorenylidene)-dianiline; 2,2′-bis(trifluoromethyl)-4,4′-diaminobiphenyl; 3,3′-dichloro-4,4′-diaminodiphenylmethane; 2,2′-dichloro-4,4′-diaminobiphenyl; 2,2′,5,5′-tetrachlorobenzidine; 2,2-bis(4-aminophenoxyphenyl)propane; 2,2-bis(4-aminophenyl)propane; 2,2-bis(4-aminophenyl)-1,1,1,3,3,3-hexafluoropropane; 4,4′-diaminodiphenyl ether; 3,4′-diaminodiphenyl ether; 1,3-bis(3-aminophenoxy)benzene; 1,3-bis(4-aminophenoxy)benzene; 1,4-bis(4-aminophenoxy)benzene; 4,4′-bis(4-aminophenoxy)biphenyl; 4,4′-bis(3-aminophenoxy)biphenyl; 2,2-bis[4-(4-aminophenoxy)phenyl]propane; 2,2-bis[4-(4-aminophenoxy)phenyl]-1,1,1,3,3,3-hexafluoropropane; 4,4′-diaminodiphenyl thioether; and 4,4′-diaminodiphenylsulfone.

An example of the polyetherketone includes polyaryletherketone disclosed in JP 2001-049110 A and represented by the following general formula (51).

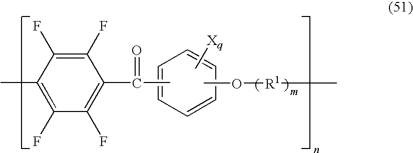

In the above formula (51), X represents a substituent, and q represents the number of the substituents. X represents a halogen atom, a lower alkyl group, a halogenated alkyl group, a lower alkoxy group, or a halogenated alkoxy group, for example. A plurality of Xs may be the same or different from each other.

Examples of the halogen atom include a fluorine atom, a bromine atom, a chlorine atom, and an iodine atom. Of those, a fluorine atom is preferred. The lower alkyl group is preferably an alkyl group having a straight chain or branched chain of 1 to 6 carbon atoms, more preferably an alkyl group having a straight chain or branched chain of 1 to 4 carbon atoms. More specifically, the lower alkyl group is preferably a methyl group, an ethyl group, a propyl group, an isopropyl group, a butyl group, an isobutyl group, a sec-butyl group, or a tert-butyl group, and particularly preferably a methyl group or an ethyl group. An example of the halogenated alkyl group includes a halide of the above lower alkyl group such as a trifluoromethyl group. The lower alkoxy group is preferably an alkoxy group having a straight chain or branched chain of 1 to 6 carbon atoms, more preferably an alkoxy group having a straight chain or branched chain of 1 to 4 carbon atoms. More specifically, the lower alkoxy group is preferably a methoxy group, an ethoxy group, a propoxy group, an isopropoxy group, a butoxy group, an isobutoxy group, a sec-butoxy group, or a tert-butoxy group, and particularly preferably a methoxy group or an ethoxy group. An example of the halogenated alkoxy group includes a halide of the above lower alkoxy group such as a trifluoromethoxy group.

In the above formula (51), q is an integer of 0 to 4. In the above formula (51), preferably, q=0, and a carbonyl group and an oxygen atom of ether bonded to both ends of a benzene ring are located in para positions.

In the above formula (51), R¹ is a group represented by the following formula (52), and m is an integer of 0 or 1.

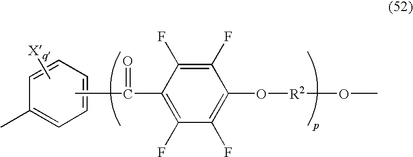

In the above formula (52), X¹ represents a substituent which is the same as X in the above formula (7), for example. In the above formula (52), a plurality of X′s may be the same or different from each other. q′ represents the number of the substituents X′. q′ is an integer of 0 to 4, and q′ is preferably 0. p is an integer of 0 or 1.

In the above formula (52), R² represents a divalent aromatic group. Examples of the divalent aromatic group include: an o-, m-, or p-phenylene group; and a divalent group derived from naphthalene, biphenyl, anthracene, o-, m-, or p-terphenyl, phenanthrene, dibenzofuran, biphenyl ether, or biphenyl sulfone. In the divalent aromatic group, hydrogen directly bonded to an aromatic group may be substituted with a halogen atom, a lower alkyl group, or a lower alkoxy group. Of those, R² is preferably an aromatic group selected from groups represented by the following formulae (53) to (59).

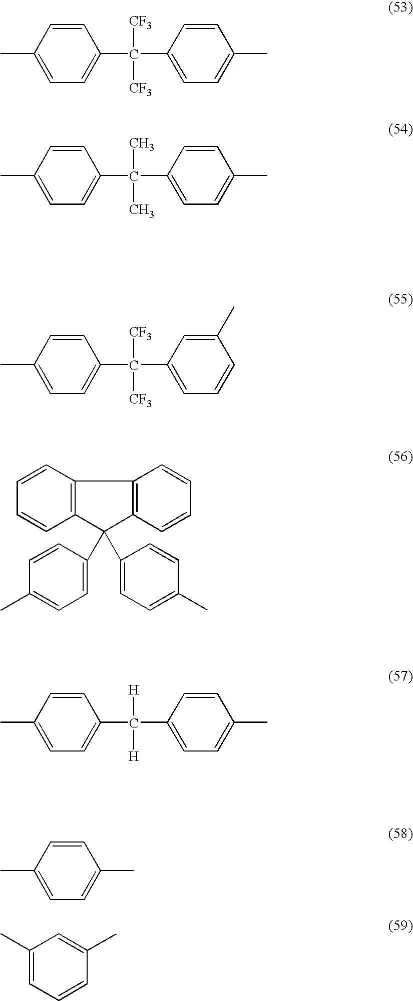

In the above formula (51), R¹ is preferably a group represented by the following formula (60). In the following formula (60), R² and p are defined as those in the above formula (52).

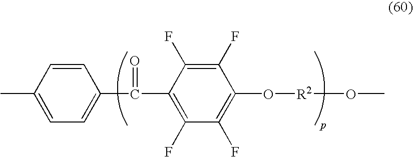

In the above formula (51), n represents a degree of polymerization. n falls within a range of 2 to 5,000, preferably within a range of 5 to 500, for example. Polymerization may involve polymerization of repeating units of the same structure or polymerization of repeating units of different structures. In the latter case, a polymerization form of the repeating units may be block polymerization or random polymerization.

Terminals of the polyaryletherketone represented by the above formula (51) are preferably a fluorine atom on a p-tetrafluorobenzoylene group side and a hydrogen atom on an oxyalkylene group side. Such polyaryletherketone can be represented by the following general formula (61), for example. In the following formula (61), n represents the same degree of polymerization as that in the above formula (51).

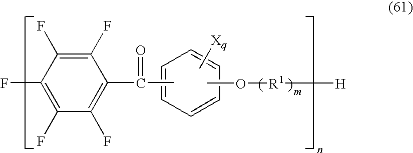

Specific examples of the polyaryletherketone represented by the above formula (51) include compounds represented by the following formulae (62) to (65). In each of the following formulae, n represents the same degree of polymerization as that in the above formula (51).

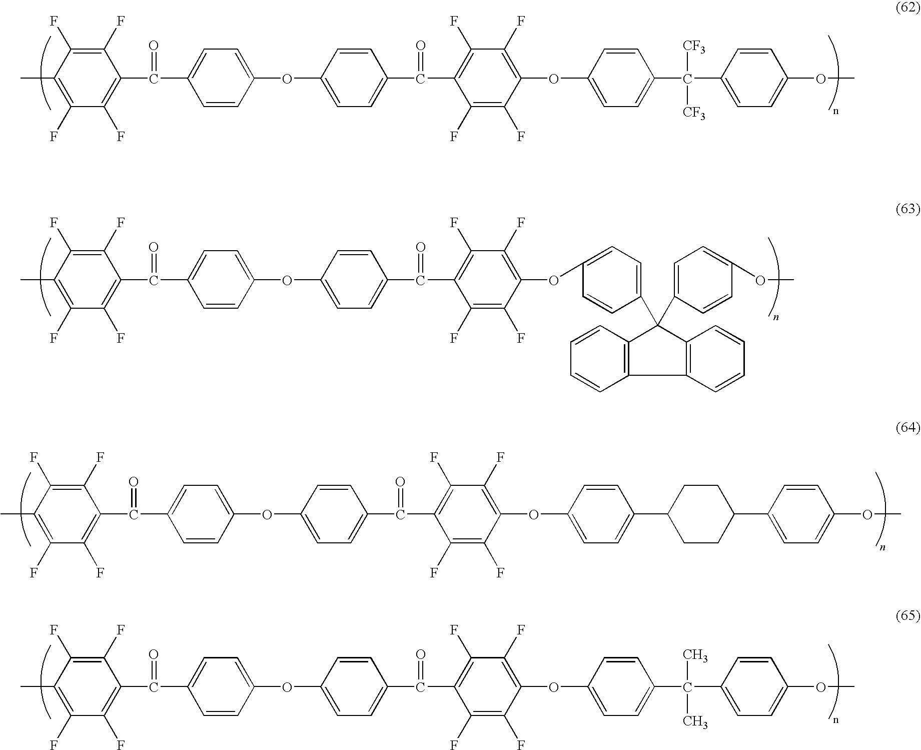

In addition, an example of polyamide or polyester includes polyamide or polyester disclosed in JP 10-508048 A. A repeating unit thereof can be represented by the following general formula (66), for example.

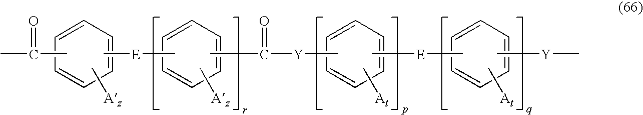

In the above formula (66), Y represents O or NH. E represents at least one selected from a covalent bond, an alkylene group having 2 carbon atoms, a halogenated alkylene group having 2 carbon atoms, a CH₂ group, a C(CX₃)₂ group (wherein, X is a halogen or hydrogen), a CO group, an O atom, an S atom, an SO₂ group, an Si(R)₂ group, and an N(R) group, for example. A plurality of Es may be the same or different from each other. In E, R is at least one of an alkyl group having 1 to 3 carbon atoms and a halogenated alkyl group having 1 to 3 carbon atoms, and is located in a meta or para position with respect to a carbonyl functional group or a Y group.

In the above formula (66), A and A′ each represent a substituent, and t and z represent the numbers of the respective substituents. p represents an integer of 0 to 3, and q represents an integer of 1 to 3. r represents an integer of 0 to 3.

A is selected from hydrogen, a halogen, an alkyl group having 1 to 3 carbon atoms, a halogenated alkyl group having 1 to 3 carbon atoms, an alkoxy group represented by OR (wherein, R is defined as above), an aryl group, a substituted aryl group prepared through halogenation or the like, an alkoxycarbonyl group having 1 to 9 carbon atoms, an alkylcarbonyloxy group having 1 to 9 carbon atoms, an aryloxycarbonyl group having 1 to 12 carbon atoms, an arylcarbonyloxy group having 1 to 12 carbon atoms and its substituted derivatives, an arylcarbamoyl group having 1 to 12 carbon atoms, and arylcarbonylamino group having 1 to 12 carbon atoms and its substituted derivatives, for example. A plurality of As may be the same or different from each other. A′ is selected from a halogen, an alkyl group having 1 to 3 carbon atoms, a halogenated alkyl group having 1 to 3 carbon atoms, a phenyl group, and a substituted phenyl group, for example. A plurality of A′s may be the same or different from each other. Examples of the substituent on a phenyl ring of the substituted phenyl group include a halogen, an alkyl group having 1 to 3 carbon atoms, a halogenated alkyl group having 1 to 3 carbon atoms, and the combination thereof. t represents an integer of 0 to 4, and z represents an integer of 0 to 3.

The repeating unit of the polyamide or polyester represented by the above formula (66) is preferably a repeating unit represented by the following general formula (67).

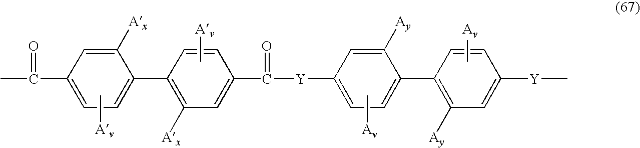

In the above formula (67), A, A′, and Y are defined as those in the above formula (66). v represents an integer of 0 to 3, preferably an integer of 0 to 2. x and y are each 0 or 1, but are not both 0.

Next, a method of producing a second optical compensation layer will be described. As a method of producing a second optical compensation layer, any suitable method can be adopted as long as the effects of the present invention are obtained.

A second optical compensation layer having a relationship of nx=ny>nz is obtained, by applying a solution of at least one kind selected from the group consisting of polyamide, polyimide, polyester, polyether ketone, polyamideimide, and polyesterimide onto the base material to form a coating film, and drying the coating film to form the polymer layer on the base material.

Any appropriate solvent may be used as the application liquid (for applying a polymer solution to a base material) for coating the solution. Examples thereof include halogenated hydrocarbons such as chloroform, dichloromethane, carbon tetrachloride, dichloroethane, tetrachloroethane, trichloroethylene, tetrachloroethylene, chlorobenzene, and orthodichlorobenzene; phenols such as phenol, varachlorophenol; aromatic hydrocarbons such as benzene, toluene, xylene, methoxybenzene, and 1,2-dimethoxybenzene; ketone-based solvents such as acetone, methyl ethyl ketone, methyl isobutyl ketone, cyclohexanone, cyclopentanone, 2-pyrrolidone, and N-methyl-2-pyrrolidone; ester-based solvents such as ethyl acetate and butyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide-based solvents such as dimethylformamide and dimethylacetamide; nitrile-based solvents such as acetonitrile and butyronitrole; ether-based solvents such as diethyl ether, dibutyl ether, and tetrahydrofuran; carbon disulfide; and cellosolves such as ethyl cellosolve and butyl cellosolve. Of those, methyl isobutyl ketone is preferred because it indicates high solubility with non-liquid crystalline materials and does not corrode the base material. The solvents may be used alone or in combination.

As the concentration of the above-mentioned non-liquid crystalline polymer in the application liquid, any appropriate concentration can be adopted as long as the above-mentioned optical compensation layer is obtained and coating can be performed. For example, the application liquid contains a non-liquid crystalline polymer in an amount of preferably 5 to 50 parts by weight, and more preferably 10 to 40 parts by weight with respect to 100 parts by weight of the solvent. The solution in such a concentration range has viscosity that makes coating easier.

The application liquid can further contain various additives such as a stabilizer, a plasticizer, and metals as required.

The application liquid can further contain other different resins as required. Examples of such other resins include various kinds of general-purpose resins, an engineering plastic, a thermoplastic resin, and a thermosetting resin. By using such resins together, an optical compensation layer having suitable mechanical strength and durability depending on the purpose can be formed.

Examples of the general-purpose resins include polyethylene (PE), polypropylene (PP), polystyrene (PS), polymethylmethacrylate (PMMA), an ABS resin, and an AS resin. Examples of the engineering plastic include polyacetate (POM), polycarbonate (PC), polyamide (PA: nylon), polyethylene terephthalate (PET), and polybutylene terephthalate (PBT). Examples of the thermoplastic resin include polyphenylenesulfide (PPS), polyethersulfon (PES), polyketone (PK), polyimide (PI), polycyclohexanedimethanol terephthalate (PCT), polyarylate (PAR), and liquid crystal polymer (LCP). Examples of the thermosetting resin include an epoxy resin and a phenol novolak resin.

The kind and amount of the above different resin to be added to the application liquid can be set appropriately depending upon the purpose. For example, such a resin can be added to the non-liquid crystalline polymer in an amount of preferably 0 to 50% by weight and more preferably 0 to 30% by weight.

Examples of the coating methods for the coating solution include a spin coating, a roll coating, a flow coating, a printing, a dip coating, a casting deposition, a bar coating, and a gravure printing. Further, in coating, a method of superimposing a polymer layer may also be employed as required.

After coating, for example, a solvent in the above solution is evaporated to be removed by drying such as natural drying, air drying, and heat drying (e.g., 60 to 250° C.), whereby an optical compensation layer is formed.

A-4. Adhesive Layer

As the adhesive layer provided between the first optical compensation layer and the second optical compensation layer, any suitable adhesive layer is selected depending upon the purpose. Preferably, any suitable adhesive is used. By using the adhesive layer, it is not necessary to directly apply a coating layer of liquid crystal or the like (for example, an organic solvent in which a liquid crystal monomer is dissolved) to the first optical compensation layer, so the corrosion of the first optical compensation layer by an organic solvent can be prevented, and the first optical compensation layer can be prevented from becoming opaque. Further, when the polarizing plate with an optical compensation layer of the present invention is incorporated into an image display apparatus, the relationship among optical axes of the respective layers is prevented from being shifted, and the respective layers can be prevented from being damaged by rubbing against one another. Further, the interface reflection between layers can be reduced, and a contrast in the case of use in an image display apparatus can be enhanced. A representative example of an adhesive of which each of the above adhesive layers is formed is a curable adhesive. Representative examples of the curable adhesive include: a photocurable adhesive such as a ultraviolet curable adhesive; a moisture curable adhesive; and a thermosetting adhesive. Specific examples of the thermosetting adhesive include thermosetting resin-based adhesives each made of, for example, an epoxy resin, an isocyanate resin, or a polyimide resin. Specific examples of the moisture curable adhesive include isocyanate resin-based moisture curable adhesives. A moisture curable adhesive (in particular, an isocyanate resin-based moisture curable adhesive) is preferred. A moisture curable adhesive is excellent in ease of use because of the following reason: the adhesive reacts with, for example, moisture in the air or adsorbed water on the surface of an adherend, or an active hydrogen group of, for example, a hydroxyl group or a carboxyl group to cure, so the adhesive can be cured naturally by being left after the application of the adhesive. Further, there is no need for heating the adhesive to a high temperature for the curing of the adhesive, so a second optical compensation layer are not heated to high temperatures during lamination (bonding). As a result, the cracking or the like of each of a second optical compensation layer at the time of the lamination of the layer can be prevented even when the layer has an extremely small thickness as in the case of the present invention because there is no worry about the shrinkage due to heating. In addition, a curable adhesive hardly expands even when the adhesive is heated after its curing. Therefore, the cracking or the like of a second optical compensation layer can be prevented even when the layer has an extremely small thickness, and a liquid crystal panel to be obtained is used under high temperature conditions. It should be noted that the above term “isocyanate resin-based adhesive” is a general name for a polyisocyanate resin-based adhesive, a polyurethane resin adhesive, and the like.

For example, a commercially available adhesive may be used as the curable adhesive, or various curable resins may be dissolved or dispersed in a solvent to prepare a curable resin adhesive solution (or dispersion). In the case where the solution (or dispersion) is prepared, a ratio of the curable resin in the solution is preferably 10 to 80 wt %, more preferably 20 to 65 wt %, especially preferably 25 to 65 wt %, and most preferably 30 to 50 wt % in solid content. Any appropriate solvent may be used as the solvent to be used depending on the kind of the curable resin, and specific examples thereof include ethyl acetate, methyl ethyl ketone, methyl isobutyl ketone, toluene, and xylene. They may be used alone or in combination.

An application amount of the adhesive may be appropriately set depending on purposes. For example, the application amount is preferably 0.3 to 3 ml, more preferably 0.5 to 2 ml, and most preferably 1 to 2 ml per area (cm²) of the second optical compensation layer.

After the application, the solvent in the adhesive is evaporated through natural drying or heat drying as required. A thickness of the adhesive layer to be obtained is preferably 0.1 to 20 μm, more preferably 0.5 to 15 μm, and most preferably 1 to 10 μm.

Microhardness of the adhesive layer is preferably 0.1 to 0.5 GPa, more preferably 0.2 to 0.5 GPa, and most preferably 0.3 to 0.4 GPa. Correlation between Microhardness and Vickers hardness is known, and thus the Microhardness can be converted into Vickers hardness. Microhardness can be calculated from indentation depth and indentation load by using, for example, a thin-film hardness meter (trade name, MH4000 or MHA-400, for example) manufactured by NEC Corporation.

A method of forming the adhesive layer is appropriately selected depending upon the purpose. For example, the curing temperature of the adhesive is appropriately set depending upon an adhesive to be used or the like. The curing temperature is preferably 30 to 90° C., and more preferably 40 to 60° C. By curing an adhesive in these temperature ranges, foaming can be prevented from being generated in the adhesive layer. Further, rapid curing can be prevented. Further, the curing time is appropriately set depending upon an adhesive to be used, the above curing temperature, and the like. The curing time is preferably 5 hours or more, and more preferably about 10 hours. By forming an adhesive layer under these conditions, an adhesive layer that is easy to handle can be obtained.

A-5. Polarizer

Any appropriate polarizer may be employed as the polarizer in accordance with the purpose. Examples thereof include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based aligned film such as a dehydrated product of a polyvinyl alcohol-based film or a dehydrochlorinated product of a polyvinyl chloride-based film. Of those, a polarizer prepared by adsorbing a dichromatic substance such as iodine on a polyvinyl alcohol-based film and uniaxially stretching the film is particularly preferred because of high polarized dichromaticity. A thickness of the polarizer is not particularly limited, but is generally about 1 to 80 μm.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

Washing the polyvinyl alcohol-based film with water not only allows removal of contamination on a film surface or washing away of an antiblocking agent, but also provides an effect of preventing uneveness such as uneven coloring by swelling the polyvinyl alcohol-based film. The stretching of the film may be performed after coloring of the film with iodine, performed during coloring of the film, or performed followed by coloring of the film with iodine. The stretching may be performed in an aqueous solution of boric acid or potassium iodide, or in a water bath.

A-6. Protective Layer

The protective layer may employ any appropriate film which can be used as a protective layer of a polarizing plate. Specific examples of a material to be included as a main component of the film include: a cellulose-based resin such as triacetyl cellulose (TAC); and a transparent resin such as a polyester-based resin, a polyvinyl alcohol-based resin, a polycarbonate-based resin, a polyamide-based resin, a polyimide-based resin, a polyethersulfone-based resin, a polysulfone-based resin, a polystyrene-based resin, a polynorbornene-based resin, a polyolefin-based resin, an acrylic resin, and an acetate-based resin. Other examples thereof include: a thermosetting resin and a UV-curable resin, such as an acrylic resin, an urethane-based resin, an acrylurethane-based resin, an epoxy-based resin, and a silicone-based resin. Still another example thereof is a glassy polymer such as a siloxane-based polymer. Further, a polymer film described in JP 2001-343529 A (WO 01/37007) may also be used. A material for the film may employ a resin composition containing a thermoplastic resin having a substituted or unsubstituted imide group on a side chain, and a thermoplastic resin having a substituted or unsubstituted phenyl group and nitrile group on a side chain, for example. A specific example thereof is a resin composition containing an alternating isobutene/N-methylmaleimide copolymer, and an acrylonitrile/styrene copolymer. The polymer film may be an extrusion molded product of the resin composition described above, for example. TAC, a polyimide-based resin, a polyvinyl alcohol-based resin, and a glassy polymer are preferred. TAC is more preferred.

The protective layer is preferably transparent and colorless. Specifically, a thickness direction retardation value is preferably −90 nm to +90 nm, more preferably −80 nm to +80 nm, and most preferably −70 nm to +70 nm.

As the thickness of the above protective layer, any appropriate thickness can be adopted as long as the above preferred thickness direction retardation is obtained. Specifically, the thickness of the protective layer is preferably 5 mm or less, more preferably 1 mm or less, still more preferably 1 to 500 μm, and still even more preferably 5 to 150 μm.

The protective layer provided on an outer side (opposite side of the optical compensation layer) of a polarizer can be subjected to hard coat treatment, antireflection treatment, anti-sticking treatment, antiglare treatment, and the like, if required.

A-7. Polarizing Plate with an Optical Compensation Layer

As shown in FIG. 1 as a typical example, the polarizing plate with an optical compensation layer of the present invention includes a polarizer 11, a first optical compensation layer 12, an adhesive layer 13, and a second optical compensation layer 14 in the stated order. Preferably, a pressure-sensitive adhesive layer (not shown) or an adhesive layer (not shown) may be provided between the polarizer 11 and the first optical compensation layer 12.

By filling the gaps between the respective layers with a pressure-sensitive adhesive layer or an adhesive layer, when the laminate is incorporated in an image display apparatus, the relationships between optical axes of the respective layers can be prevented from being shifted, and the respective layers can be prevented from damaging each other by rubbing. Further, the interface reflection between the layers can be reduced, and a contrast can also be increased when the laminate is used in the image display apparatus.

The thickness of the pressure-sensitive adhesive layer may appropriately be set in accordance with the intended use or adhesive strength. To be specific, the pressure-sensitive adhesive layer has a thickness of preferably 1 μm to 100 μm, more preferably 5 μm to 50 μm, and most preferably 10 μm to 30 μm.

Any appropriate pressure-sensitive adhesive may be employed as the pressure-sensitive adhesive forming the pressure-sensitive adhesive layer. Specific examples thereof include, for example, a solvent-type pressure-sensitive adhesive, a nonaqueous emulsion-type pressure-sensitive adhesive, an aqueous pressure-sensitive adhesive, and a hot-melt pressure-sensitive adhesive. Of those, a solvent-type pressure-sensitive adhesive containing an acrylic polymer as a base polymer is preferably used, because it exhibits appropriate pressure-sensitive adhesive properties (wetness, cohesiveness, and adhesion) with respect to the polarizer, the first optical compensation layer, and the second optical compensation layer, and provides excellent optical transparency, weatherability, and heat resistance.

A typical example of the adhesive forming the adhesive layer is a curable adhesive. Typical examples of the curable adhesive include a photo-curable adhesive such as an UV-curable adhesive, a moisture-curable adhesive, and a thermosetting adhesive.

A specific example of the thermosetting adhesive is a thermosetting resin-based adhesive formed of an epoxy resin, an isocyanate resin, a polyimide resin, or the like. A specific example of the moisture-curable adhesive is an isocyanate resin-based moisture-curable adhesive. The moisture-curable adhesive (in particular, an isocyanate resin-based moisture-curable adhesive) is preferred. The moisture-curable adhesive is cured through a reaction with moisture in air, water adsorbed on a surface of an adherend, an active hydrogen group of a hydroxyl group, a carboxyl group, or the like. Thus, the adhesive may be applied and then cured naturally by leaving at stand, and has excellent operability. Further, the moisture-curable adhesive requires no heating for curing, and thus is not heated at the time of bonding between the layers. Therefore, the deterioration of respective layers due to heating can be inhibited. Note that the isocyanate resin-based adhesive is a general term for a polyisocyanate-based adhesive, a polyurethane resin adhesive, and the like.

For example, a commercially available adhesive may be used as the curable adhesive, or various curable resins may be dissolved or dispersed in a solvent to prepare a curable resin adhesive solution (or dispersion). In the case where the curable resin adhesive solution (or dispersion) is prepared, a ratio of the curable resin in the solution (or dispersion) is preferably 10 to 80 wt %, more preferably 20 to 65 wt %, and still more preferably 30 to 50 wt % in solid content. Any appropriate solvent may be used as the solvent to be used in accordance with the type of curable resin, and specific examples thereof include ethyl acetate, methyl ethyl ketone, methyl isobutyl ketone, toluene, and xylene. They may be used alone or in combination.

An application amount of the adhesive between respective layers may appropriately be set in accordance with the purpose. For example, the application amount is preferably 0.3 to 3 ml, more preferably 0.5 to 2 ml, and still more preferably 1 to 2 ml per area (cm²) of a main surface of each layer.

After the application, the solvent in the adhesive is evaporated through natural drying or heat drying as required. A thickness of the adhesive layer thus obtained is preferably 0.1 to 20 μm, more preferably 0.5 to 15 μm, and still more preferably 1 to 10 μm.

Microhardness of the adhesive layer is preferably 0.1 to 0.5 GPa, more preferably 0.2 to 0.5 GPa, and still more preferably 0.3 to 0.4 GPa. Note that the correlation between Microhardness and Vickers hardness is known, and thus Microhardness may be converted into Vickers hardness. Microhardness may be calculated from indentation depth and indentation load by using a thin-film hardness meter (MH4000 (trade name) or MHA-400 (trade name), for example) manufactured by NEC Corporation.

A-8. Other Structural Components of Polarizing Plate

The polarizing plate with an optical compensation layer of the present invention may be provided with other optical layers. As the other optical layers, any appropriate optical layers may be employed in accordance with the purpose and the types of image display apparatus. Specific examples thereof include a liquid crystal film, a light scattering film, a diffraction film, and another optical compensation layer (retardation film).

The polarizing plate with an optical compensation layer of the present invention may further include a pressure-sensitive adhesive layer or adhesive layer as an outermost layer on at least one side thereof. In this way, the polarizing plate includes the pressure-sensitive adhesive layer or adhesive layer as an outermost layer, to thereby facilitate lamination with another member (for example, a liquid crystal cell) and prevent the polarizing plate from peeling off from another member. Any appropriate materials may be used as the material for forming the pressure-sensitive adhesive layer. Specific examples of the pressure-sensitive adhesive are described above. Specific examples of the adhesive layer are described above. Preferably, a material having excellent moisture absorption property or excellent heat resistance is used for preventing foaming or peeling due to moisture absorption, degradation in optical properties due to difference in thermal expansion or the like, warping of the liquid crystal cell, and the like.

For practical use, a surface of the pressure-sensitive adhesive layer or adhesive layer is covered by any appropriate separator to prevent contamination until the polarizing plate is actually used. The separator may be formed by a method of providing a release coat on any appropriate film by using a releasing agent such as a silicone-based, long chain alkyl-based, or fluorine-based, or molybdenum sulfide as required.

Each of the layers of the polarizing plate with an optical compensation layer of the present invention may be subjected to treatment with a UV absorber such as a salicylic ester-based compound, a benzophenone-based compound, a benzotriazole-based compound, a cyanoacrylate-based compound, or a nickel complex salt-based compound, to thereby impart UV absorbing property.

B. Method of Producing a Polarizing Plate with an Optical Compensation Layer

As a method of producing a polarizing plate with an optical compensation layer of the present invention, any suitable method can be adopted in a range in which the effects of the present invention are not impaired. For example, a first optical compensation layer is laminated on a polarizer (a protective layer may be provided, if required) via the pressure-sensitive layer or adhesive layer. By transferring the second optical compensation layer (coating layer) via the adhesive layer on a side of the first optical compensation layer opposite to the polarizer, a polarizing plate with an optical compensation layer of the present invention can be obtained.

Next, an example of a specific procedure of the method of producing a polarizing plate with an optical compensation layer of the present invention will be described. For simplicity, the state in which a polarizer, a first optical compensation layer, and a second optical compensation layer (see above for detail) are formed will be described. Note that the production method is not limited to this method.

The polarizer can be laminated at any suitable point in the production method of the present invention. For example, the polarizer may be laminated previously on the protective layer, the second optical compensation layer may be attached (transferred) after the protective layer and the polarizer are laminated on the first optical compensation layer, or the protective layer and the polarizer may be laminated after the second optical compensation layer is attached to the first optical compensation layer.

As a method of laminating the protective layer and polarizer, any suitable lamination method (for example, bonding) can be adopted. The bonding can be performed using any suitable adhesive or pressure-sensitive adhesive. The kind of the adhesive or pressure-sensitive adhesive can be selected appropriately depending upon the kind of an adherend (more specifically, a protective layer and a polarizer). Specific examples of the adhesive include adhesive formed of polymer such as acrylic, vinyl alcohol-based, silicone-based, polyester-based, polyurethane-based, or polyether-based polymer, an isocyanate resin-based adhesive, and a rubber-based adhesive. Specific examples of the pressure-sensitive adhesive include acrylic, vinyl alcohol-based, silicone-based, polyester-based, polyurethane-based, polyether-based, isocyanate-based, or rubber-based pressures-sensitive adhesive.

As the thickness of the adhesive or pressure-sensitive adhesive, any suitable thickness can be adopted. The thickness is preferably 10 to 200 nm, more preferably 30 to 180 nm, and most preferably 50 to 150 nm.

In the case of using a protective layer on which a polarizer is previously laminated (hereinafter, which may be referred to as polarizing plate), a first optical compensation layer is laminated on the polarizing plate via the pressure-sensitive adhesive layer or the adhesive layer. At this time, the first optical compensation layer can be laminated so that an angle formed by optical axes of the polarizing plate and the first optical compensation layer is in a desired range. Preferably, the first optical compensation layer is laminated so that a slow axis thereof forms 40° to 50°, more preferably 42° to 48°, and particularly preferably 44° to 46° in a counterclockwise direction with respect to an absorption axis of the polarizer of the polarizing plate.

Next, the adhesive (for example, an isocyanate resin-based adhesive) is applied to a side of the first optical compensation layer opposite to the polarizing plate. As the application method, any suitable method (typically, a method of flow-spreading an application liquid) can be adopted. Specific examples include a roll coating, a spin coating, a wire bar coating, a dip coating, an extrusion coating, a curtain coating, and a spray coating. Of those, a spin coating and an extrusion coating are preferred in terms of an application efficiency.

The second optical compensation layer is transferred to the first optical compensation layer via the adhesive. As the method of transfer, any suitable method is adopted. For example, there is a roll coating. The transfer further includes the step of peeling the base material from the second optical compensation layer.

Next, the adhesive is cured. The curing temperature is appropriately set depending upon an adhesive to be used. The curing temperature is preferably 30 to 90° C., and more preferably 40 to 60° C. By curing an adhesive in these temperature ranges, foaming can be prevented from being generated in an adhesive layer. Further, rapid curing can be prevented. Further, the curing time is set appropriately depending upon an adhesive to be used, the above curing temperature, and the like. The curing time is preferably 5 hours or more, and more preferably about 10 hours. The thickness of an adhesive layer to be obtained is preferably 0.1 μm to 20 μm, more preferably 0.5 μm to 15 μm, and most preferably 1 μm to 10 μm.

Thus, a polarizing plate with an optical compensation layer of the present invention is obtained.

C. Application Purposes of Polarizing Plate with an Optical Compensation Layer

The polarizing plate with an optical compensation layer of the present invention may suitably be used for various image display apparatuses (for example, a liquid crystal display apparatus and a self-luminous display apparatus). Specific examples of applicable image display apparatuses include a liquid crystal display apparatus, an EL display, a plasma display (PD), and a field emission display (FED). In the case where the polarizing plate with an optical compensation layer of the present invention is used for a liquid crystal display apparatus, the polarizing plate with an optical compensation layer is useful for prevention of light leakage in black display and for compensation of viewing angle. The polarizing plate with an optical compensation layer of the present invention is preferably used for a liquid crystal display apparatus of a VA mode, and is particularly preferably used for a reflective or semi-transmission-type liquid crystal display apparatus of a VA mode. In the case where the polarizing plate with an optical compensation layer of the present invention is used for an EL display, the polarizing plate with an optical compensation layer is useful for prevention of electrode reflection.

D. Image Display Apparatus

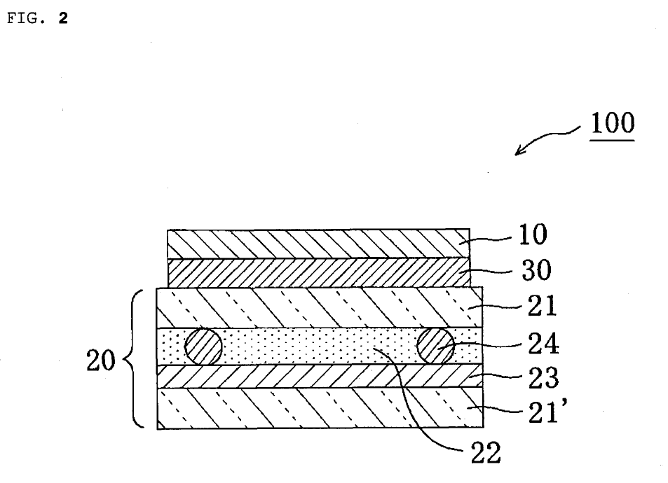

As an example of the image display apparatus of the present invention, a liquid crystal display apparatus will be described. Herein, a liquid crystal panel used in a liquid crystal display apparatus will be described. As the configurations of the liquid crystal display apparatus and the other components, any suitable configurations can be employed depending upon the purpose. In the present invention, a liquid crystal display apparatus of a VA mode is preferred, and a reflection and semi-transmission-type liquid crystal display apparatus of a VA mode is particularly preferred. FIG. 2 is a schematic cross-sectional view of a liquid crystal panel in a preferred embodiment of the present invention. Herein, a liquid crystal panel for a reflection-type liquid crystal display apparatus will be described. A liquid crystal panel 100 has a liquid crystal cell 20, a retardation plate 30 placed on an upper side of the liquid crystal cell 20, and a polarizing plate 10 placed on an upper side of the retardation plate 30. As the retardation plate 30, any suitable retardation plate can be employed depending upon the purpose and the alignment mode of the liquid crystal cell. The retardation plate 30 can be omitted depending upon the purpose and the alignment mode of the liquid crystal cell. The polarizing plate 10 is a polarizing plate with an optical compensation layer of the present invention as described above. The liquid crystal cell 20 includes a pair of glass base materials 21, 21′, and a liquid crystal layer 22 as a display medium placed between the base materials. A reflective electrode 23 is provided on the liquid crystal layer 22 side of the lower base material 21′. A color filter (not shown) is provided on the upper base material 21. An interval (cell gap) between the base materials 21, 21′ is controlled by spacers 24.

For example, in the case of a reflection type VA mode, in the liquid crystal display apparatus (liquid crystal panel) 100, liquid crystal molecules are aligned perpendicular to surfaces of the base materials 21, 21′ under no voltage application. Such vertical alignment can be realized by placing nematic liquid crystal having negative dielectric anisotropy between base materials on which vertical alignment films (not shown) are formed. When linearly polarized light passing through the polarizing plate 10 is incident upon the liquid crystal layer 22 from the surface of the upper base material 21 in this state, the incident light travels in a major axis direction of the vertically aligned liquid crystal molecules. Since birefringence does not occur in the major axis direction of the liquid crystal molecules, the incident light travels without changing a polarization azimuth, is reflected by the reflective electrode 23, passes through the liquid crystal layer 22 again, and is output from the upper base material 21. The polarization state of the output light does not change from the polarization state at the time of incidence, so the output light passes through the polarizing plate 10, whereby a display in a bright state is obtained. When a voltage is applied between the electrodes, the major axes of the liquid crystal molecules are aligned in parallel to the surfaces of the base materials. The liquid crystal molecules exhibit birefringence with respect to the linearly polarized light incident to the liquid crystal layer 22 in this state, and the polarization state of the incident light changes in accordance with the tilt of the liquid crystal molecules. Under the application of a predetermined maximum voltage, the light reflected from the reflective electrode 23 and output from the upper base material becomes linearly polarized light, for example, with the polarization azimuth thereof rotated by 90°, and is absorbed by the polarizing plate 10, whereby a display in a dark state is obtained. When the state is returned to a no voltage application state again, the display in a dark state can be returned to the display in a bright state by the alignment regulation force. Further, the tilt of the liquid crystal molecules is controlled by changing the applied voltage to change the intensity of the transmitted light from the polarizing plate 10, whereby a gray-scale display can be performed.

### EXAMPLE

Hereinafter, the present invention will be described more specifically by way of examples. However, the present invention is not limited to these examples.

### Example 1

### Production of a Polarizing Plate

A commercially available polyvinyl alcohol (PVA) film (manufactured by Kurary Co., Ltd.) was dyed in an aqueous solution containing iodine, and uniaxially stretched about 6 times between rolls with different speeds in an aqueous solution containing boric acid, whereby a long polarizer was obtained. Commercially available TAC films (manufactured by Fujiphoto Film Co., Ltd.) were attached to both surfaces of the polarizer with a PVA-based adhesive, whereby a polarizing plate (protective layer/polarizer/protective layer) with an entire thickness of 100 μm was obtained. The polarizing plate was punched to a size of 20 cm (longitudinal side)×30 cm (lateral side) so that the absorption axis of the polarizer was placed in a longitudinal direction.

### Production of a First Optical Compensation Layer

A stretched modified polycarbonate film (PUREACE WR (trade name) manufactured by Teijin Ltd.) with a thickness of 77 μm was used as a film for a first optical compensation layer. This film had a refractive index profile of nx>ny=nz, exhibited wavelength dispersion properties in which a retardation value that is an optical path difference between extraordinary light and ordinary light is smaller toward a shorter wavelength side, and had an in-plane retardation Re₁ of 147 nm. This film was punched into a size of 20 cm (longitudinal side)×30 cm (lateral side), whereby a first optical compensation layer was obtained so that the delay axis was placed in a longitudinal direction.

### Production of a Second Optical Compensation Layer

90 parts by weight of the nematic liquid crystal compound represented by the following Formula (10), 10 parts by weight of a chiral agent represented by the following Formula (38), 5 parts by weight of a photopolymerization initiator (Irgacure 907 manufactured by Ciba Specialty Chemicals Inc.), and 300 part by weight of methyl ethyl ketone were mixed uniformly to prepare a liquid crystal application liquid. A base material (biaxially stretched PET film) was coated with the liquid crystal application liquid by spin coating, subjected to heat treatment at 80° C. for 3 minutes, and polymerized by the irradiation of UV light (20 mJ/cm², wavelength: 365 nm), whereby a long second optical compensation layer (cholesteric alignment fixed layer) having a refractive index profile of nx=ny>nz was formed. The film was punched to a size of 20 cm (longitudinal side)×30 cm (lateral side) to obtain a second optical compensation layer. The thickness of the second optical compensation layer was 2 μm, the in-plane retardation Re₂ thereof was 0 nm, and the thickness direction retardation Rth₂ thereof was 110 nm. The wavelength dependence of a birefringent index Δn (=|nₑ−nₒ|, nₑ: extraordinary light refractive index, nₒ: ordinary light refractive index) of the second optical compensation layer obtained as described above decreased with an increase in a wavelength. A retardation R(λ) (=Δn×d, d: thickness of an optical compensation layer) had positive wavelength dispersion properties.

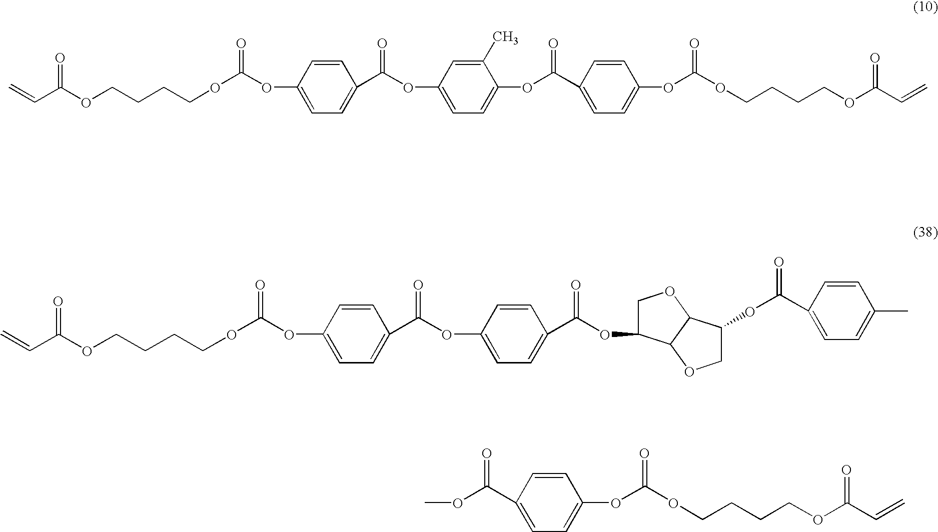

### Production of a Polarizing Plate with an Optical Compensation Layer

The second optical compensation layer was attached (transferred) to the obtained first optical compensation layer so that an isocyanate resin-based adhesive layer (thickness: 5 μm) applied to a main surface of the second optical compensation layer was opposed to the first optical compensation layer. The adhesive layer was cured by heating at 50° C. for about 10 hours. Then, the obtained polarizing plate was attached to a side of the first optical compensation layer opposite to the adhesive layer, using an acrylic pressure-sensitive adhesive (thickness: 20 μm). At this time, the polarizing plate was laminated on the first optical compensation layer so that a slow axis of the first optical compensation layer formed an angle of 45° in a counterclockwise direction with respect to an absorption axis of the polarizer of the polarizing plate. Finally, the laminated film was punched to a size of 4.0 cm (longitudinal side)×5.3 cm (lateral side), and the base material (biaxially stretched PET film) supporting the second optical compensation layer was peeled, whereby a polarizing plate with an optical compensation layer (1) was obtained.

### Example 2

A cellulose ester film (KA film manufactured by Kaneka Corporation) with a thickness of 110 μm (weight average molecular weight Mw=3×10⁴) was subjected to free-end longitudinal uniaxial stretching at 150° C. by 1.3 times, and used as a film for a first optical compensation layer. This film had a refractive index profile of nx>ny=nz, exhibited wavelength dispersion properties that a retardation value, which is an optical path difference between extraordinary light and ordinary light, is smaller toward a short wavelength side, exhibited an acetyl substitution degree (DSac) of 0.04 and a propionyl substitution degree (DSpr) of 2.76, and had an in-plane retardation Re₁ of 111 nm. Further, the thickness was 100 μm. This film was punched to a size of 20 cm (longitudinal side)×30 cm (lateral side) to obtain a first optical compensation layer. At this time, a slow axis was aligned in a longitudinal direction. A polarizing plate with an optical compensation layer (2) was obtained in the same way as in Example 1 except for using the first optical compensation layer obtained above.

### Example 3

A cellulose ester film (KA film manufactured by Kaneka Corporation) with a thickness of 110 μm (weight average molecular weight Mw=3×10⁴) was subjected to free-end longitudinal uniaxial stretching at 155° C. by 1.5 times, and used as a film for a first optical compensation layer. This film had a refractive index profile of nx>ny=nz, exhibited wavelength dispersion properties that a retardation value, which is an optical path difference between extraordinary light and ordinary light, is smaller toward a short wavelength side, exhibited an acetyl substitution degree (DSac) of 0.04 and a propionyl substitution degree (DSpr) of 2.76, and had an in-plane retardation Re₁ of 134 nm. Further, the thickness was 98 μm. This film was punched to a size of 20 cm (longitudinal side)×30 cm (lateral side) to obtain a first optical compensation layer. At this time, a slow axis was aligned in a longitudinal direction. A polarizing plate with an optical compensation layer (3) was obtained in the same way as in Example 1 except for using the first optical compensation layer obtained above.

### Example 4

A cellulose ester film (KA film manufactured by Kaneka Corporation) with a thickness of 110 μm (weight average molecular weight Mw=3×10⁴) was subjected to free-end longitudinal uniaxial stretching at 160° C. by 2.3 times, and used as a film for a first optical compensation layer. This film had a refractive index profile of nx>ny=nz, exhibited wavelength dispersion properties that a retardation value, which is an optical path difference between extraordinary light and ordinary light, is smaller toward a short wavelength side, exhibited an acetyl substitution degree (DSac) of 0.04 and a propionyl substitution degree (DSpr) of 2.76, and had an in-plane retardation Re₁ of 139 nm. Further, the thickness was 81 μm. This film was punched to a size of 20 cm (longitudinal side)×30 cm (lateral side) to obtain a first optical compensation layer. At this time, a slow axis was aligned in a longitudinal direction. A polarizing plate with an optical compensation layer was obtained in the same way as in Example 1 except for using the first optical compensation layer obtained above.

### Comparative Example 1

### Production of a Second Optical Compensation Layer

The liquid crystal application liquid used in the second optical compensation layer of Example 1 was directly coated (spin-coated) to the first optical compensation layer of Example 1, subjected to heat treatment 80° C. for 3 minutes, and polymerized by the irradiation of UV light (20 mJ/cm², wavelength: 365 nm), whereby a long second optical compensation layer (cholesteric alignment fixed layer) having a refractive index profile of nx=ny>nz was formed. This coating film was punched to a size of 20 cm (longitudinal side)×30 cm (lateral side) to obtain a second optical compensation layer. The thickness of the second optical compensation layer was 2 μm, the in-plane retardation Re₂ thereof was 0 nm, and the thickness direction retardation Rth₂ thereof was 120 nm.

### Production of a Polarizing Plate with an Optical Compensation Layer

The polarizing plate used in Example 1 was attached to a side of the obtained first optical compensation layer opposite to the second optical compensation layer using an acrylic pressure-sensitive adhesive (thickness: 20 μm). At this time, the polarizing plate was laminated on the first optical compensation layer so that a slow axis of the first optical compensation layer formed an angle of 45° in a counterclockwise direction with respect to an absorption axis of the polarizer of the polarizing plate. Then, the laminated film was punched to a size of 4.0 cm (longitudinal side)×5.3 cm (lateral side), whereby a polarizing plate with an optical compensation layer (C1) was obtained.

### Comparative Example 2

### Production of a Second Optical Compensation Layer

A norbornene-based resin film (Arton (trade name) manufactured by JSR Corporation, thickness: 100 μm, photoelastic coefficient: 5.00×10⁻¹² m²/N) was stretched longitudinally at 175° C. by 1.27 times, and stretched laterally at 176° C. by 1.37 times, whereby a film for a long second optical compensation layer (thickness: 65 μm) having a refractive index profile of nx=ny>nz was produced. This film was punched to a size of 20 cm (longitudinal side)×30 cm (lateral side) to obtain a second optical compensation layer. The in-plane retardation Re₂ of the second optical compensation layer was 0 nm, and the thickness direction retardation Rth₂ thereof was 110 nm.

### Production of a Polarizing Plate with an Optical Compensation Layer

The polarizing plate and the first optical compensation layer obtained in Example 1, and the second optical compensation layer obtained above were laminated in the stated order. They were laminated so that a slow axis of the first optical compensation layer formed an angle of 45° in a counterclockwise direction with respect to an absorption axis of the polarizer of the polarizing plate. The polarizing plate and the first optical compensation layer, and the first optical compensation layer and the second optical compensation layer were laminated using an acrylic pressure-sensitive adhesive (thickness: 20 μm). Then, a laminated film was punched to a size of 4.0 cm (longitudinal side)×5.3 cm (lateral side) to obtain a polarizing plate with an optical compensation layer (C2).

### Evaluation 1

### Viewing Angle Properties

The polarizing plate with an optical compensation layer of Examples 1 to 4 and Comparative Examples 1 and 2 obtained above were laminated on glass base material side on a viewing side of a liquid crystal cell of a VA mode (mobile telephone, model No.: Q01iS, manufactured by Sharp Corporation) via an acrylic pressure-sensitive adhesive (thickness: 20 μm). At this time, in Example 1, the polarizing plate with an optical compensation layer was attached so that the glass base material and the second optical compensation layer were opposed to each other. Thus, a liquid crystal display apparatus of a VA mode was obtained. Regarding the liquid crystal cell of a VA mode with a polarizing plate with an optical compensation layer mounted thereon, viewing angle properties were measured using a viewing angle property measuring apparatus (EZ Contrast manufactured by ELDIM).

The viewing angle of the liquid crystal cell using each polarizing plate with optical compensation layer of Examples 1 to 4 was remarkably larger than each liquid crystal cell using the polarizing plate with an optical compensation layer of Comparative Examples 1 and 2.

### INDUSTRIAL APPLICABILITY

The polarizing plate with an optical compensation layer of the present invention may suitably be used for various image display apparatuses (for example, a liquid crystal display apparatus and a self-luminous display apparatus).

1. A polarizing plate with an optical compensation layer, comprising, in the stated order:
a polarizer;
a first optical compensation layer;
an adhesive layer; and
a second optical compensation layer, wherein:
the first optical compensation layer has a refractive index profile of nx>ny=nz, exhibits wavelength dispersion properties that an in-plane retardation Re₁ is smaller toward a short wavelength side, and has an in-plane retardation Re₁ of 90 to 160 nm; and
the second optical compensation layer is a coating layer and has a refractive index profile of nx=ny>nz, an in-plane retardation Re₂ of 0 to 20 nm, a thickness direction retardation Rth₂ of 30 to 300 nm, and a thickness of 0.5 to 10 μm.

2. A polarizing plate with an optical compensation layer according to claim 1, wherein the adhesive layer is formed of an isocyanate resin-based adhesive layer.

3. A polarizing plate with an optical compensation layer according to claim 1, wherein the first optical compensation layer is a stretched film layer and contains polycarbonate having a fluorene skeleton.

4. A polarizing plate with an optical compensation layer according to claim 1, wherein the first optical compensation layer is a stretched film layer and contains a cellulose-based material.

5. A polarizing plate with an optical compensation layer according to claim 4, wherein the first optical compensation layer contains a cellulose-based material in which an acetyl substitution degree (DSac) and a propionyl substitution degree (DSpr) satisfy 2.0≦DSac+DSpr≦3.0 and 1.0≦DSpr≦3.0.

6. A polarizing plate with an optical compensation layer according to claim 5, wherein the first optical compensation layer is a stretched film layer obtained by subjecting the cellulose-based material to free-end uniaxial stretching at 110° C. to 170° C. in a major axis direction by 1.1 times to 2.5 times.

7. A polarizing plate with an optical compensation layer according to claim 4, wherein a weight average molecular weight Mw of the cellulose-based material is in a range of 3×10³ to 3×10⁵.

8. A polarizing plate with an optical compensation layer according to claim 1, wherein the first optical compensation layer is a stretched film layer and contains two or more kinds of an aromatic polyester polymers having different wavelength dispersion properties.

9. A polarizing plate with an optical compensation layer according to claim 1, wherein the first optical compensation layer is a stretched film layer and contains a copolymer having two or more kinds of monomer units derived from a monomer forming a polymer having different wavelength dispersion properties.

10. A polarizing plate with an optical compensation layer according to claim 1, wherein the first optical compensation layer is a complex film layer in which two or more kinds of stretched film layers having different wavelength dispersion properties are laminated.

11. A polarizing plate with an optical compensation layer according to claim 1, wherein the second optical compensation layer is formed of a cholesteric alignment fixed layer.

12. A polarizing plate with an optical compensation layer according to claim 1, wherein the second optical compensation layer is formed of a layer containing a non-liquid crystalline material.

13. A polarizing plate with an optical compensation layer according to claim 1, wherein the second optical compensation layer is formed by transferring the second optical compensation layer formed onto a base material by coating to the first optical compensation layer via the adhesive layer.

14. A liquid crystal panel, comprising:
the polarizing plate with an optical compensation layer according to claim 1; and
a liquid crystal cell.

15. A liquid crystal panel according to claim 14, wherein the liquid crystal cell is a VA mode of a reflection type or semi-transmission type.

16. A liquid crystal display apparatus, comprising the liquid crystal panel according to claim 14.

17. An image display apparatus, comprising the polarizing plate with an optical compensation layer according to claim 1.
